(19) United States
(12) Patent Application Publication
(10) Pub. No.: US 2019/0095428 A1
(43) Pub. Date: Mar. 28, 2019

(54) INFORMATION PROCESSING APPARATUS, DIALOGUE PROCESSING METHOD, AND DIALOGUE SYSTEM

(71) Applicant: HITACHI, LTD., Tokyo (JP)

(72) Inventors: Yu Asano, Tokyo (JP); Makoto Iwayama, Tokyo (JP)

(73) Assignee: HITACHI, LTD., Tokyo (JP)

(21) Appl. No.: 16/059,233

(22) Filed: Aug. 9, 2018

(30) Foreign Application Priority Data
Sep. 26, 2017 (JP) 2017-185298

(51) Int. Cl. G06F 17/27; G10L 17/22; G10L 15/18; G10L 15/187; G10L 15/22

(52) U.S. Cl. CPC G06F 17/2795; G10L 17/22; G10L 15/22; G10L 15/187; G10L 15/1822

(57) ABSTRACT

An information processing apparatus that has a processor and a memory and analyzes a dialogue log data including an input sentence from a user and an answer to the input sentence as an output sentence includes a failure location detecting unit that receives the dialogue log data and detects a failure location of a dialogue from the dialogue log data, a failure cause analyzing unit that analyzes a failure cause from the dialogue log data corresponding to the failure location, a confirmation processing unit that generates and outputs a question sentence from the dialogue log data depending on the failure cause, and a knowledge registration processing unit that receives an answer to the question sentence and adds the answer as new knowledge to a dialogue data for obtaining an output sentence from the input sentence.

### CLAIM OF PRIORITY

The present application claims priority from Japanese patent application JP 2017-185298 filed on Sep. 26, 2017, the content of which is hereby incorporated by reference into this application.

### BACKGROUND OF THE INVENTION

### 1. Field of the Invention

The present invention relates to an information processing apparatus, a dialogue processing method, and a dialogue system.

### 2. Description of the Related Art

In recent years, in accordance with the advent of an advanced service using information technology (IT), digital divide has increased, and in accordance with globalization or lifestyle diversification, communication has become complicated. For this reason, it is difficult for only existing staff to provide various interpersonal services such as facility guidance at airports or stations where it is required to cope with various languages or window services at banks or local governments handling a plurality of complicated services. In order to support such advanced services, dialogue systems such as robots or voice assistants have been put to practical use.

The dialogue system is required to be capable of rapidly answering a question that could not be answered. For example, when an answer to a question of wanting to know opening hours of any store is not prepared, an answer such as “Opening hours are from 10 o'clock to 19 o'clock.” needs to be registered in the dialogue system.

In addition, even though an answer to a question such as “Where is a feeding room?” is prepared by the dialogue system, common vocabularies are small in a question such as “I'd like to use a baby room, where is it?”, and thus, there is a case where it is impossible to answer the question. In this case, the question such as “I'd like to use a baby room, where is it?” needs to be registered in the dialogue system.

In order to be capable of answering a question that could not be answered once, it is necessary to find a failure location of a dialogue from an enormous amount of dialogue log data, analyze a failure cause, and take action as described above depending on an analysis result.

Up to now, techniques for analyzing the dialogue log data in the dialogue system or techniques for dealing with the failure location of the dialogue have been considered, and techniques disclosed in JP 2017-76161 A and Jiwei Li, Alexander H. Miller, Sumit Chopra, Marc' Aurelio Ranzato, Jason Weston, Learning Through Dialogue Interactions by asking questions, Proceedings of the 5th International Conference on Learning Representations (2017) have been known. JP 2017-76161 A discloses a technique for visualizing an analysis result of log data.

In detail, in order to quantify and analyze character strings included in the log data, a tree structure diagram and a similarity are displayed in which overlapping character strings of the log data are grouped into one character string and common parts of different character strings are taken as nodes. In addition, a distribution diagram is also displayed by mapping the similarity and time information of the log data to each other. It is possible to grasp a trend of a user input (dialogue data) or improve analysis efficiency of the user input by visualizing the log data as described above.

Jiwei Li, Alexander H. Miller, Sumit Chopra, Marc' Aurelio Ranzato, Jason Weston, Learning Through Dialogue Interactions by asking questions, Proceedings of the 5th International Conference on Learning Representations (2017) discloses a method of learning by asking back a user a question when an answer that a system can prepare to a question from the user lacks in confidence (is low in terms of a score of certainty). For example, assume that the user inputs “Which movvie did Tom Hanks sttar in?” The word “movvie” is an erroneous input of “movie”, and the word “sttar” is an erroneous input of “star.”

In this case, the dialogue system asks back the user “What do you mean?” in order to confirm the question from the user. For this, when the user changes the previous words to input words that does not include an error such as “I mean which film did Tom Hanks appear in?”, the dialogue system is able to interpret the question, and can answer “Forest Gump.” In Jiwei Li, Alexander H. Miller, Sumit Chopra, Marc' Aurelio Ranzato, Jason Weston, Learning Through Dialogue Interactions by asking questions, Proceedings of the 5th International Conference on Learning Representations (2017), the user teaches correctness of the answer, such that the dialogue system learns what kind of return question the dialogue system should ask back the user and whether or not the dialogue system should ask the user a return question.

### SUMMARY OF THE INVENTION

In the prior art, there was a problem in that it is difficult for the dialogue system itself to perform confirmation for learning knowledge required for answering the question that could not be answered. For example, when it is not clear whether or not the “feeding room” and the “baby room” are synonymous with each other, it was impossible to perform confirmation by asking a person a question such as “are the “feeding room” and the “baby room” synonymous with each other?”

In addition, a cost required for manually performing detection of the failure location of the dialogue, analysis, setting of an answer depending on an analysis result, and the like, is high. For this reason, there was a problem in that many people or a lot of labor are required in order to rapidly take action. In addition, experts of the dialogue system could be required to find the failure location of the dialogue and analyze the failure cause, and experts of tasks could be required to register new questions or answers.

The present invention has been made in view of the abovementioned problems, and an object of the present invention is to easily expand knowledge for answering a question that a dialogue system could not answer.

The present invention is an information processing apparatus that has a processor and a memory and analyzes a dialogue log data including an input sentence from a user and an answer to the input sentence as an output sentence, including a failure location detecting unit that receives the dialogue log data and detects a failure location of a dialogue from the dialogue log data, a failure cause analyzing unit that analyzes a failure cause from the dialogue log data corresponding to the failure location, a confirmation processing unit that generates and outputs a question sentence from the dialogue log data depending on the failure cause, and a knowledge registration processing unit that receives an answer to the question sentence and adds the answer as new knowledge to a dialogue data for obtaining an output sentence from the input sentence.

According to the present invention, it is possible to expand knowledge for answering a question that the information processing apparatus could not answer only by answering a question from the information processing apparatus (the dialogue system).

### BRIEF DESCRIPTION OF THE DRAWINGS

FIG. 1 is a block diagram showing an example of an information processing apparatus constituting a dialogue system according to a first embodiment of the present invention;

FIG. 2A is a view showing an example of a dialogue data according to the first embodiment of the present invention;

FIG. 2B is a view showing an example of a dialogue log data according to the first embodiment of the present invention;

FIG. 2C is a view showing an example of a dialogue log analysis data according to the first embodiment of the present invention;

FIG. 2D is a view showing an example of a confirmation item data according to the first embodiment of the present invention;

FIG. 3 is a flowchart showing an example of processing performed by the information processing apparatus according to the first embodiment of the present invention;

FIG. 4A is a flowchart showing an example of failure location extraction processing performed at the time of learning according to the first embodiment of the present invention;

FIG. 4B is a flowchart showing an example of failure location extraction processing performed at the time of identifying according to the first embodiment of the present invention;

FIG. 5 is a view showing an example of the existing dialogue log data to which a decision result on a success or a failure of a dialogue is given according to the first embodiment of the present invention;

FIG. 6A is a flowchart showing an example of failure cause analysis processing performed at the time of learning according to the first embodiment of the present invention;

FIG. 6B is a flowchart showing an example of failure cause analysis processing performed at the time of identifying according to the first embodiment of the present invention;

FIG. 7 is a view showing an example of the existing dialogue log data to which a correct answer to the failure cause is given according to the first embodiment of the present invention;

FIG. 8 is a flowchart showing an example of confirmation processing and knowledge confirmation processing according to the first embodiment of the present invention;

FIG. 9A is a view showing an example of a dialogue log data according to the first embodiment of the present invention;

FIG. 9B is a view showing an example of a confirmation item data according to the first embodiment of the present invention;

FIG. 9C is a view showing an example of a confirmation item data to which a confirmation result is given according to the first embodiment of the present invention;

FIG. 9D is a view showing an example of a dialogue log analysis data to which a confirmation result is given according to the first embodiment of the present invention;

FIG. 10 is a view showing an example of knowledge confirmation processing using a robot according to the first embodiment of the present invention;

FIG. 11 is a view showing an example of knowledge confirmation processing using a chat bot according to the first embodiment of the present invention;

FIG. 12A is a view showing an example of knowledge confirmation processing using a table format according to the first embodiment of the present invention;

FIG. 12B is a view showing an example of knowledge confirmation processing using a paraphrase candidate data having a table format according to the first embodiment of the present invention;

FIG. 13 is a view showing an example of a dialogue data in knowledge registration processing according to the first embodiment of the present invention;

FIG. 14A is a view showing an example of a dialogue log data in which a synonym is considered according to a second embodiment of the present invention;

FIG. 14B is a view showing an example of a confirmation item data according to the second embodiment of the present invention;

FIG. 14C is a view showing an example of a dialogue log analysis data according to the second embodiment of the present invention;

FIG. 14D is a view showing an example of a dialogue data according to the second embodiment of the present invention;

FIG. 15 is a view showing an example of a confirmation item data according to a third embodiment of the present invention;

FIG. 16 is a flowchart showing an example of failure cause analysis processing according to the second embodiment of the present invention;

FIG. 17 is a block diagram showing an example of a dialogue system according to the third embodiment of the present invention; and

FIG. 18 is a block diagram showing an example of a dialogue system according to a fourth embodiment of the present invention.

### DESCRIPTION OF THE PREFERRED EMBODIMENTS

Embodiments will be described in detail with reference to the drawings. However, the present invention should not be construed as being limited to contents mentioned in embodiments described below.

In addition, in the present specification, components expressed in singular forms will include plural forms unless the context clearly indicates otherwise. As described below, in the present embodiment, knowledge of a dialogue is expanded by detecting a failure location from a dialogue log, analyzing a failure cause, outputting a question toward a confirmer depending on an analysis result, and adding new knowledge based on an answer result. Hereinafter, embodiments will be described.

### First Embodiment

### <1. Entire Configuration of Dialogue System>

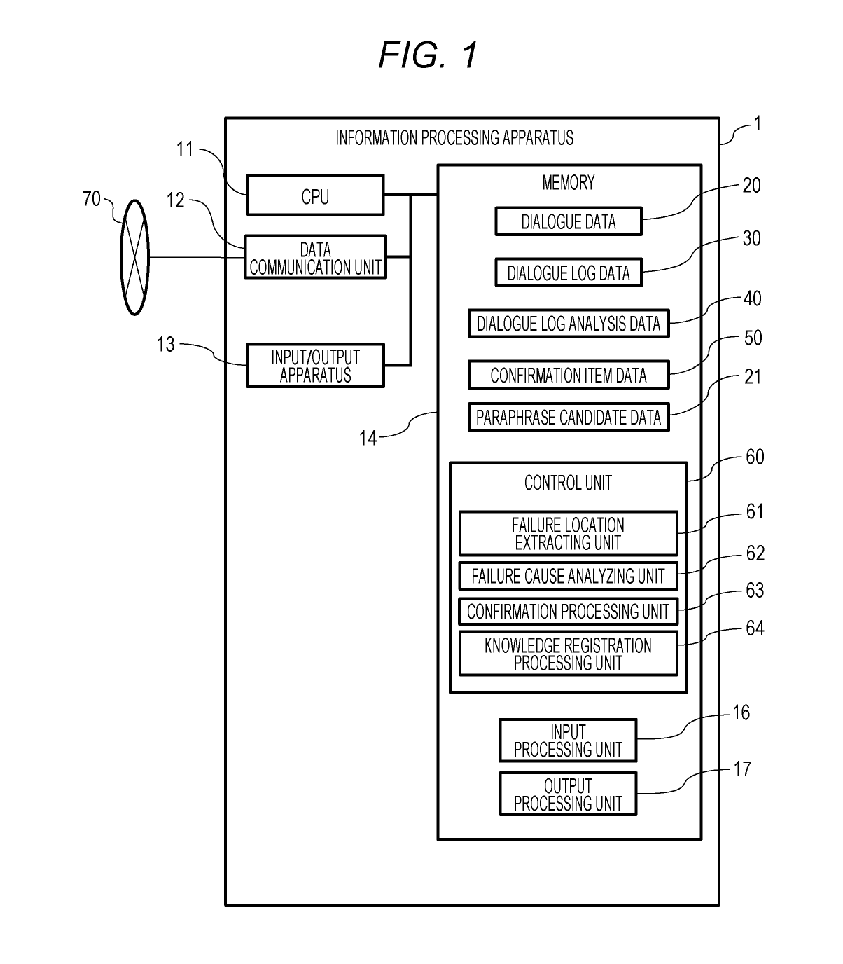

FIG. 1 is a block diagram showing an example of a configuration of an information processing apparatus 1 constituting a dialogue system according to a first embodiment.

The dialogue system is configured by the information processing apparatus 1 such as a computer as a specific example. The information processing apparatus 1 includes a central processing unit (CPU) 11, an input/output apparatus 13 such as a keyboard or an image monitor, and a memory 14 including a magnetic disk apparatus or a semiconductor memory apparatus. In addition, the information processing apparatus 1 may include a data communication unit 12 as an interface for exchanging data with the outside. The data communication unit 12 is connected to, for example, an external network 70. It should be noted that the input/output apparatus does not only mean an apparatus including both of input and output functions, but also means an apparatus including only an input function, an apparatus including only an output function, and an apparatus including both of an input and an output.

In the first embodiment, functions such as calculation or control are implemented in cooperation with other hardware with respect to predetermined processing by executing programs stored in the memory 14 by the CPU 11. The programs executed by the CPU 11, functions thereof, or means that implement the functions may be referred to as “functions”, “means”, “portions”, “units”, “modules”, or the like.

In FIG. 1, functions executed by the CPU 11 based on software are conceptually shown as a control unit 60, an input processing unit 16, and an output processing unit 17. Programs for implementing these functions are stored in the memory 14. In addition, a dialogue data 20, a paraphrase candidate data 21, a dialogue log data 30, a dialogue log analysis data 40, a confirmation item data 50, and the like, are stored as data used by the respective programs in the memory 14.

The programs may be embedded and provided in advance in a read only memory (ROM), or the like, or may be recorded and provided or be distributed as a file of an installable format or an executable format in a computer-readable recording medium such as a compact disk (CD)-ROM, a CD-R, or a digital versatile disk (DVD). Furthermore, the above programs may be stored on a computer connected to a network such as the Internet, and may be provided or distributed by downloading through a network.

The dialogue data 20, the dialogue log data 30, the dialogue log analysis data 40, and the confirmation item data 50 stored in the memory 14 can be input and output through the input/output apparatus 13. In the first embodiment, an example is shown in which the dialogue data 20, the dialogue log data 30, the dialogue log analysis data 40, and the confirmation item data 50 are output from the information processing apparatus 1. However, the present invention is not limited thereto. For example, these data can be output from an output apparatus such as a display, a screen, or a speaker provided outside the dialogue system, and a user confirming the output can further input a question (or a response) to the information processing apparatus 1.

In addition, the input/output apparatus 13 can include an input apparatus such as a keyboard, a mouse, a touch panel, or a microphone, and an output apparatus such as a display, a touch panel, or a speaker.

The control unit 60 controls processing that refers to the dialogue log data 30, detects a failure location from the dialogue log data 30, analyzes a failure cause, outputs a question sentence to a confirmer depending on an analysis result, and receives an answer result to register (add) new knowledge. The confirmer of the first embodiment is a person who provides an answer for avoiding a failure, for example, an administrator or a user of the information processing apparatus 1.

The input processing unit 16 is a processing unit that performs input processing required for the present system, such as converting an answer sentence input from the confirmer into a text. The output processing unit 17 is a processing unit that performs output processing required for the present system, such as outputting the question sentence.

In the dialogue system according to the first embodiment, a dialogue is executed by the control unit 60, the input processing unit 16, and the output processing unit 17 of the information processing apparatus 1.

For example, the input processing unit 16 includes a voice recognition unit (not shown), and converts a voice received from the input apparatus such as the microphone into a text. The control unit 60 receives the converted text as a question, refers to the dialogue data 20, searches an answer (or a response) data from the dialogue data 20, and outputs a search result. In the first embodiment, an example of selecting N search results and determining a system output sentence from a certainty factor is shown.

The output processing unit 17 includes a voice synthesizing unit (not shown), generates a voice from the output search result, and outputs the voice from the output apparatus such as the speaker. The control unit 60 accumulates logs of the dialogue in the dialogue log data 30.

Dialogue processing by the voice or the text may use any known or well-known technique, and is thus not described in detail in the first embodiment. In the first embodiment, detection of a failure of a dialogue from the dialogue log data 30, analysis of a failure cause, and expansion of new knowledge depending on an analysis result will be described.

The above configuration may be constituted by a single computer as shown in FIG. 1, or may be constituted by other computers in which the respective functional units of an input apparatus, an output apparatus, a processing apparatus, and a storage apparatus are connected to each other by a network. In addition, in the first embodiment, functions equivalent to functions configured by software can also be implemented by hardware such as a field programmable gate array (FPGA) or an application specific integrated circuit (ASIC).

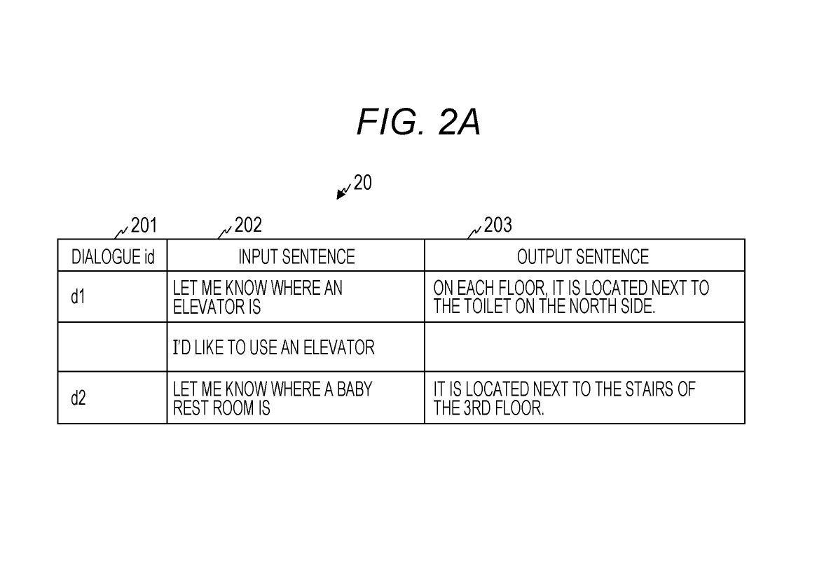

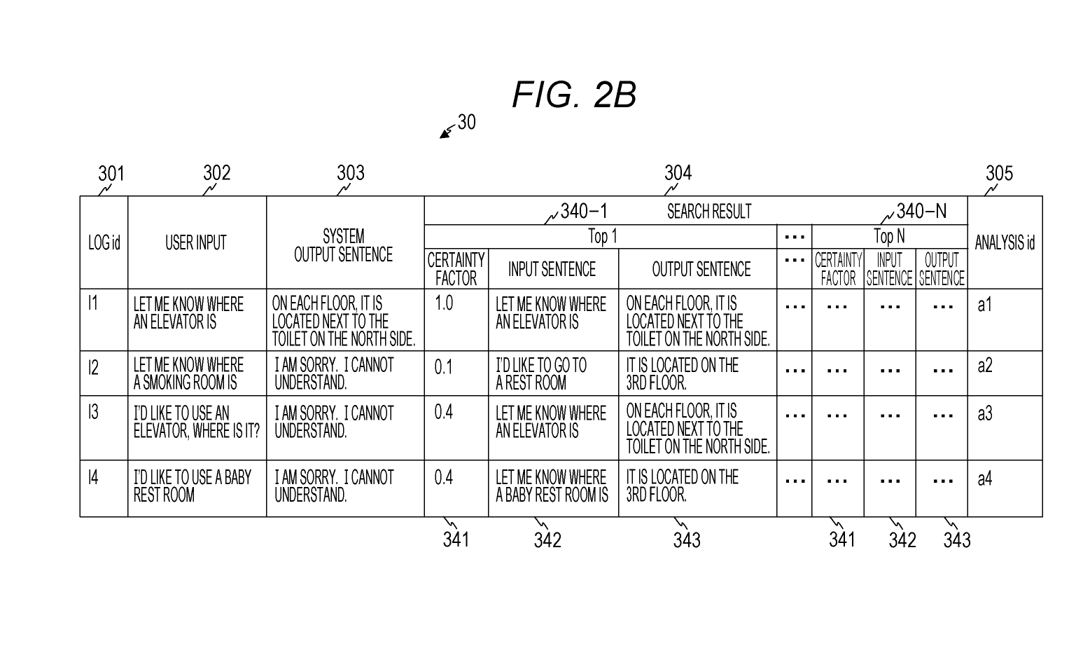

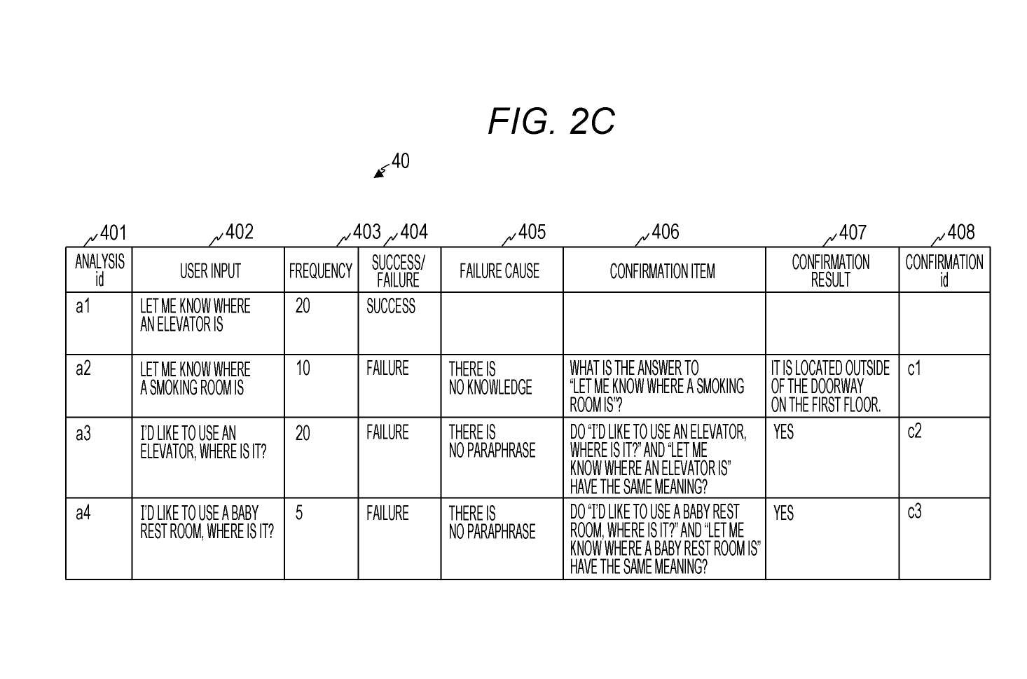

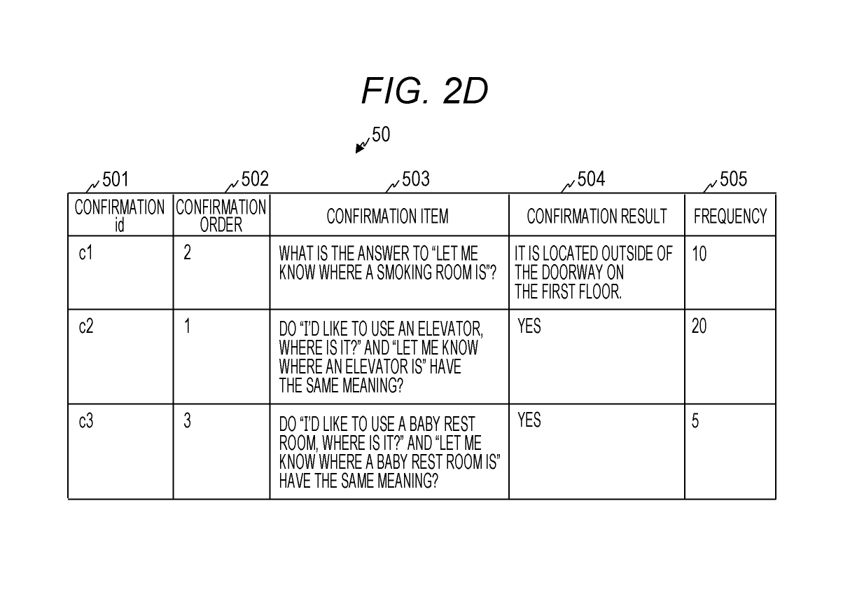

In FIGS. 2A to 2D, examples of the respective data used by the dialogue system are shown.

FIG. 2A is a view showing an example of the dialogue data 20. The dialogue data 20 includes three items of a “dialogue id” 201, an “input sentence” 202, and an “output sentence” 203 in one entry.

The “dialogue id” 201 is an identifier for identifying the dialogue data. For example, an input sentence of a dialogue id d1 is “Let me know where an elevator is”, and an output sentence of the dialogue id d1 is “On each floor, it is located next to the toilet on the north side.” By using such a dialogue data 20, the control unit 60 can provide an answer such as “On each floor, it is located next to the toilet on the north side.” when “Let me know where an elevator is” is input from a user.

In addition, when a plurality of paraphrase sentences are considered and are to be registered in the input sentence 202, the paraphrase sentences are input under the original input sentence 202. In this case, the dialogue id and the output sentence are not input. It is assumed that the dialogue id is given for each output sentence 203.

FIG. 2B is a view showing an example of the dialogue log data 30. The dialogue log data 30 stores the logs of the dialogue output by the control unit 60. The dialogue log data 30 includes five major items of a log id 301, a user input 302, a system output sentence 303, a search result 304, and an analysis id 305.

The “log id” 301 is an identifier for identifying the dialogue log data. In the dialogue log data 30, the “system output sentence” 303 output for the “user input” 302 is recorded. The user input 302 stores a value obtained by converting a question or an inquiry by a user's utterance into a text. When the question or the inquiry of the user is input as a text data, the text data can be stored in the user input 302.

The system output sentence 303 is a result obtained by searching an answer (or a response) to the user input 302 from the dialogue data 20 and selecting an optimum dialogue data 20 among search results. A technique for selecting or generating an optimum system output sentence 303 from the user input 302 may be any known or well-known technique, and is thus not described in detail in the first embodiment.

In addition, a data on the “search result” 304 that determines the system output sentence 303 is also recorded. In this example, sets of certainty factors 341, input sentences 342, and output sentences 343 of the tops 1 to N (N is a natural number) of the search result are stored as search results 340-1 to 340-N.

When a certainty factor 341 of the top 1 search result 340-1 is equal to or larger than a predetermined threshold value (a value of 0 to 1), an output sentence 343 of Top 1 is set as a system output sentence 303, and when the certainty factor 341 of the top 1 search result 340-1 is less than the predetermined threshold value, “I am sorry. I cannot understand.” is set as the system output sentence 303. In the “analysis id” 305, an analysis id of the dialogue log analysis data 40 corresponding to each log is set as described below.

FIG. 2C is a view showing an example of the dialogue log analysis data 40. An analysis result performed by the control unit 60 is stored in the dialogue log analysis data 40.

The dialogue log analysis data 40 includes eight items. An “analysis id” 401 is an identifier in which a correspondence relationship between the dialogue log analysis data 40 and the dialogue log data 30 is set. A “user input” 402, a “frequency” 403, a “success/failure” 404, a “failure cause” 405, a “confirmation item” (a question sentence) 406, a “confirmation result” 407, and a “confirmation id” 408 corresponding to the “analysis id” 401 are included in a first row.

The analysis id 401 is an identifier assigned by the control unit 60 at the time of generating or updating the dialogue log analysis data 40. One analysis id 401 can be associated with a plurality of dialogue log data 30.

A value of the user input 302 of the dialogue log data 30 is stored in the user input 402. The dialogue log analysis data 40 is generated based on a value obtained by excluding overlaps of the dialogue log data 30 including overlapping data and calculating the number of times of overlaps as a frequency.

The number of overlaps of the user input 302 in the dialogue log data 30 is stored in the frequency 403. Whether a result of the dialogue is successful or failed is stored in the success/failure 404. A cause of the failure of the dialogue is stored in the failure cause 405. An inquiry for solving the failure is stored in the confirmation item 406. An answer corresponding to the inquiry is stored in the confirmation result 407. A confirmation id of the confirmation item data 50 corresponding to the dialogue log analysis data 40 is input in the confirmation id 408.

FIG. 2D is a view showing an example of the confirmation item data 50. The confirmation item data 50 includes five items, and a confirmation item generated by a confirmation processing unit (a question generating unit) 63 of the control unit 60 and an answer (a confirmation result) received by a knowledge registration processing unit 64 of the control unit 60 are stored in the confirmation item data 50.

A “confirmation id” 501 is an identifier for identifying the confirmation item data. A “confirmation order” 502, a “confirmation item” 503, a “confirmation result” 504, and a “frequency” 505 corresponding to the “confirmation id” 501 are included in one row of the confirmation item data 50. The above is an example of a configuration of the items in each data, and an arrangement order may be changed or other items may be included.

### <2. Description of Processing of Dialogue System>

An example of processing performed by the dialogue system is described.

### <2-1. Outline of Processing of Dialogue System>

The control unit 60 performs processing that detects a failure location from the dialogue log data 30, analyzes a failure cause with respect to the failure location, generates and outputs a question sentence to a confirmer depending on an analysis result, and register new knowledge based on an answer result, using the dialogue data 20, the dialogue log data 30, the dialogue log analysis data 40 and the confirmation item data 50.

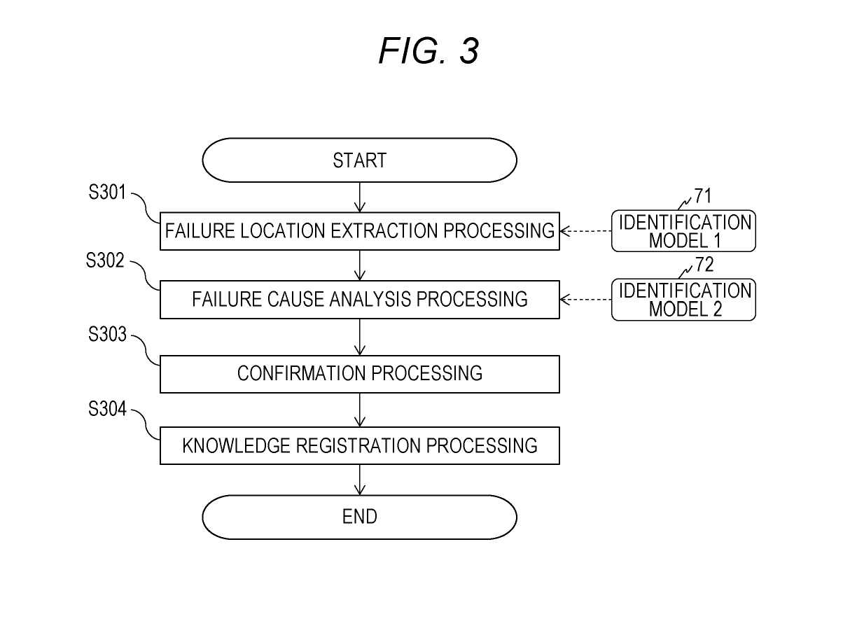

FIG. 3 is a flowchart showing an example of processing performed by the information processing apparatus 1 of the dialogue system for acquiring knowledge.

In step S301, a failure location extracting unit (or a failure location detecting unit) 61 of the control unit 60 performs processing that extracts (or detects) a location at which the dialogue has failed using the dialogue log data 30. An extraction result is input as a value of the “success/failure” 404 of the dialogue log analysis data 40. For example, it is identified whether or not an answer to a user input 302 such as “I'd like to use a feeding room, where is it?” included in the dialogue log data 30 is possible, and when the answer is impossible, an identified location is extracted as a failure location.

The failure location extracting unit 61 generates the dialogue log analysis data 40 from the dialogue log data 30, stores a “failure” in the success/failure 404 in an entry including the failure location, and stores a “success” in the success/failure 404, otherwise. The success and the failure of the dialogue are decided using an identification model 71, as described below.

In step S302, the failure cause analyzing unit 62 of the control unit 60 performs processing that analyzes a failure cause of the failure location extracted in step S301, using the dialogue log data 30. An analysis result is input as a value of the “failure cause” 405 of the dialogue log analysis data 40.

For example, two cases can be mainly considered in the failure cause 405. One case is a case where knowledge for answering the user input is not registered in the system. The other case is a case where knowledge for answering the user input 302 is registered in the dialogue system, but a method of expressing the registered knowledge is different from the user input 302.

In detail, when knowledge about a “smoking room” is not registered, in a case where “Let me know how to go to a smoking room” is input from the user, a failure cause is that the knowledge is not registered (the former). In this case, “there is no knowledge” is input in the “failure cause” 405 of the dialogue log analysis data 40.

In addition, in a case where knowledge that provides an answer such as “A smoking room is located outside of the doorway on the first floor.” to a question such as “I'd like to smoke, where is a smoking room?” is registered as the knowledge about the smoking room in the dialogue data 20 and “Let me know how to go to a smoking room” is input from the user, a failure cause is that the method of expressing the registered knowledge is different from the user input (the latter). In this case, “there is no paraphrase” is input in the “failure cause” 405 of the dialogue log analysis data 40. The cause of the failed dialogue is analyzed using an identification model 72, as described below.

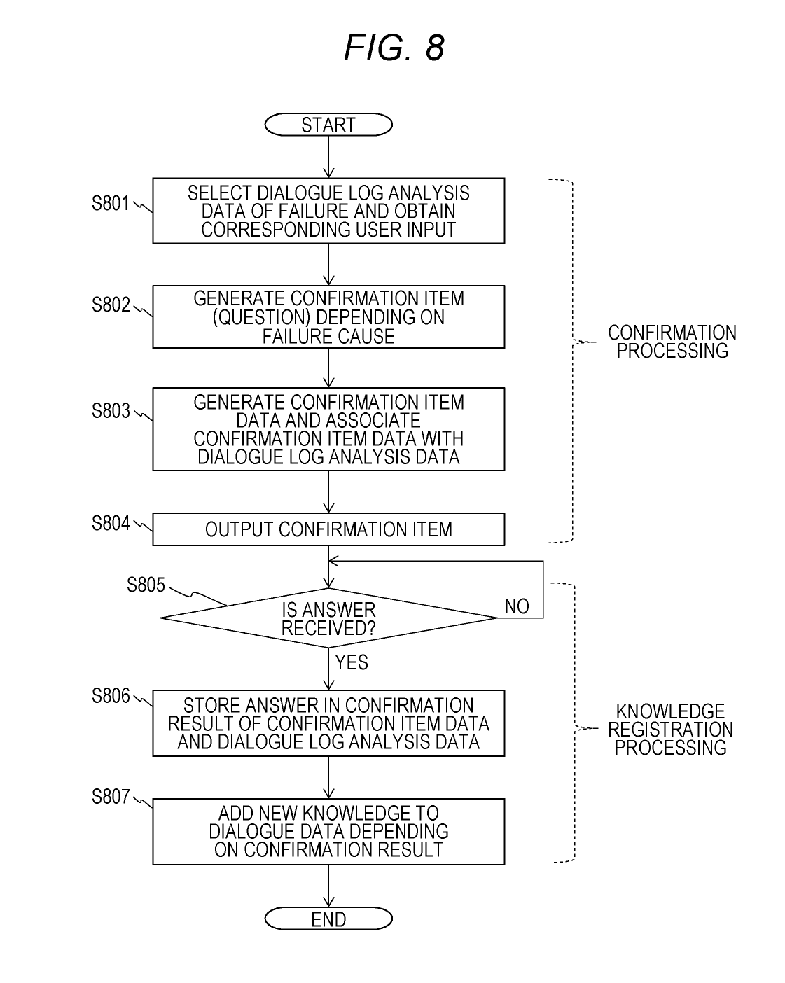

In step S303, the confirmation processing unit 63 of the control unit 60 performs processing that generates a question sentence for confirming the knowledge depending on the failure cause analyzed in step S302 and inquires of the confirmer, using the dialogue log analysis data 40. Details of the confirmation processing unit 63 will be described in detail in FIG. 8.

A confirmation (inquiry) result is added to the confirmation item data 50. For example, when it is analyzed that the cause is that the knowledge is not registered for the user input 402 such as “Let me know how to go to a smoking room” as in the former of the above example, the information processing apparatus 1 asks the confirmer “Will you tell me an answer to “Let me know how to go to a smoking room”?”

In addition, when the knowledge (the dialogue data 20) that provides an answer such as “A smoking room is located outside of the doorway on the first floor.” to a question such as “I'd like to smoke, where is a smoking room?” is registered as the knowledge about the smoking room and “Let me know how to go to a smoking room” is input from the user as in the latter of the above example, it is analyzed that the cause is that the method of expressing the registered knowledge (the input sentence 202) is different from the user input 403. In this case, when the registered question closest to the user input 402 is “I'd like to smoke, where is a smoking room?”, the information processing apparatus 1 inquires of the confirmer about “Do “Let me know how to go to a smoking room” and “I'd like to smoke, where is a smoking room?” have the same meaning?” by the confirmation processing unit 63.

The knowledge registration processing unit 64 of the control unit 60 receives an answer from the confirmer to such a question, and records the answer in the confirmation result 504 of the confirmation item data 50. The processing required for outputting the question from the confirmation processing unit 63 is performed by the output processing unit 17. When the question sentence is output as a voice, processing that converts a text of the question sentence into a voice by a predetermined voice synthesis technique is performed.

In addition, when the question sentence is output as a text by an application such as a chat bot, processing that displays the question sentence as a dialogue on a screen of the chat bot is performed. In addition, when the question sentence is output as a screen for confirmation using a table format, or the like, processing that converts the question sentence depending on a format of the screen is performed. An input of an answer sentence from the confirmer is subjected to processing required for being input by the input processing unit 16.

When the answer sentence is input as the voice, processing that converts a voice of the confirmer into a text by a predetermined speech recognition technology and converts the text into a format registered in the confirmation item data 50 is performed. In addition, when the answer sentence is input as a text by the application such as the chat bot, processing that converts the text input on a screen of the chat bot into a format registered in the confirmation item data 50 is performed. In addition, when the answer sentence is input on a screen for confirmation using a table format, or the like, processing that converts the input on the screen into a format registered in the confirmation item data 50 is performed.

In step S304, the knowledge registration processing unit 64 of the control unit 60 perform processing that updates the dialogue data 20 based on a result confirmed in step S303 using the dialogue log data 30, the dialogue log analysis data 40, and the confirmation item data 50. Details of the knowledge registration processing unit 64 will be described in detail in FIG. 8.

For example, when the confirmer provides an answer such as “A smoking room is located outside of the doorway on the first floor” to a question from the system such as “Will you tell me an answer to “Let me know how to go to a smoking room”?” in step S303, it is registered as new knowledge in the dialogue data 20 that an answer to the question such as “Let me know how to go to a smoking room” is “A smoking room is located outside of the doorway on the first floor.”

In addition, when the confirmer provides an answer such as “Yes” to a question from the system such as “Do “Let me know how to go to a smoking room” and “I'd like to smoke, where is a smoking room?” have the same meaning?”, the knowledge registration processing unit 64 registers the fact that “Let me know how to go to a smoking room” is a paraphrase of “I'd like to smoke, where is a smoking room?” as new knowledge in the dialogue data 20. In addition, when the confirmer provides an answer such as “No” to a question content, the knowledge registration processing unit 64 registers the fact that “Let me know how to go to a smoking room” is not the paraphrase of “I'd like to smoke, where is a smoking room?” as new knowledge in the dialogue data 20.

Through the above processing, the control unit 60 inputs the dialogue log data 30 to extract a log data failed in the dialogue, and analyzes the log data failed in the dialogue to specify whether the failure cause is that the “paraphrase is required” or that “there is no knowledge.”

The control unit 60 generates a question depending on the specified failure cause, and inquires through an output apparatus of the input/output apparatus 13. When an answer is received by an input apparatus of the input/output apparatus 13, the control unit 60 adds the answer as new knowledge to the dialogue data 20.

Through the processing described above, it is possible to expand the knowledge for answering the question that the dialogue system could not answer in the past only by answering the confirmation item (the question) from the dialogue system.

### <2-2. Failure Location Extraction Processing>

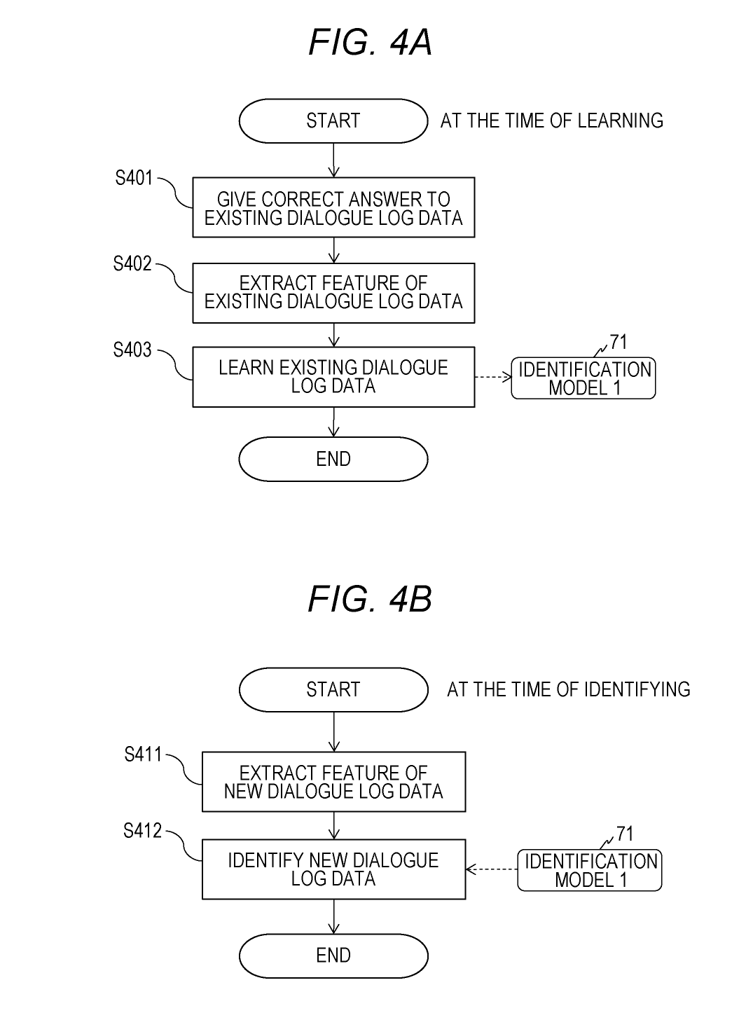

FIGS. 4A and 4B are flowcharts showing an example of failure location extraction processing, and show examples of processing at the time of learning and at the time of identifying, respectively.

FIG. 4A is a flowchart showing an example of failure location extraction processing at the time of learning. In the first embodiment, in the learning processing of FIG. 4A, the control unit 60 generates an identifier (an identification model 71) that extracts a log data failing in a dialogue from the dialogue log data 30. The control unit 60 extracts the log data failing in the dialogue in the flowchart of FIG. 4B using the identification model 71 at the time of executing the failure location extraction processing (at the time of identifying).

At the time of learning, in step S401, the failure location extracting unit 61 of the control unit 60 gives a decision result (a correct answer) on a success or a failure of the dialogue with reference to the existing dialogue log data 30. This decision may be performed using supervised machine learning, or the like.

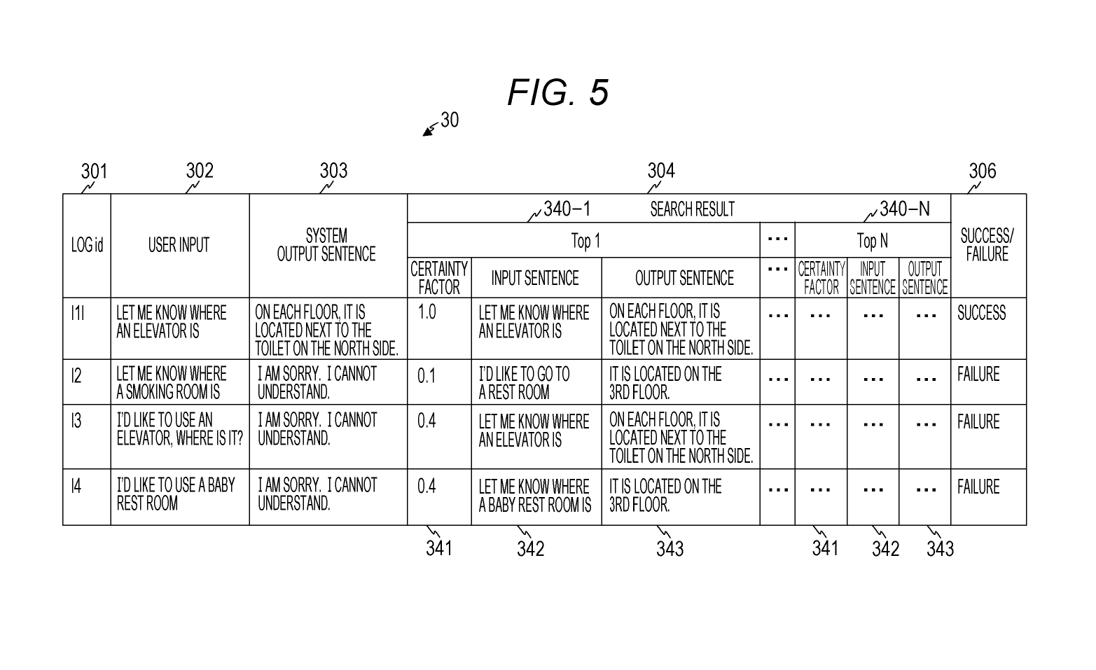

FIG. 5 is a view showing an example in which the decision result (the correct answer) 306 on the success/failure of the dialogue is given to the dialogue log data 30 shown in FIG. 2B. In FIG. 5, the analysis id 305 of FIG. 2B is omitted.

A log id 301, a user input 302, a system output sentence 303, and a search result 304 are the same as those of the dialogue log data 30 of FIG. 2B, and a “success/failure” 306 is a newly given label. It can be considered that the dialogue log data 30 includes records of which contents overlap each other, and it is also possible to use records excluding the overlaps.

In step S402, the failure location extracting unit 61 extracts features (or feature amounts) of the user input 302 and the system output sentence 303 of the existing dialogue log data 30 using the data obtained in step S401. As the features, for example, scores of various certainty factors or similarities obtained from the user input 302 and input sentences 342 and output sentences 343 of the tops 1 to N 340-1 to 340-N (N is a natural number) of the search result 304 are used. The failure location extracting unit 61 determines, for example, a search result having a maximum score as the system output sentence. For example, it is possible to use values of a search engine, BiLingual Evaluation Understudy (BLEU), or Term Frequency, Inverse Document Frequency (tf-idf) as the scores.

In step S403, the failure location extracting unit 61 learns the identifier (the identification model 71) using the features of the dialogue log data 30 of FIG. 2B extracted in step S402. In the learning processing, the identification model 71 is generated using supervised machine learning, or the like.

FIG. 4B is a view showing step S301 of FIG. 3 in detail. At the time of identifying (S301) that actually process the dialogue log data 30 of FIG. 2B, in step S411 of FIG. 4B, the failure location extracting unit 61 of the control unit 60 extracts features for a new dialogue log data 30. In the extraction of the features, the same method as that of step S402 is used.

In step S412, the failure location extracting unit 61 decides (identifies) whether the dialogue is successful or failed for the features of the new dialogue log data 30 obtained in step S411, using the identifier (the identification model 71) obtained in step S403. A decision result is output so as to be shown in, for example, a value of an item of the “success/failure” 306 of the dialogue log data 30 of FIG. 5.

### <2-3. Failure Cause Analysis Processing>

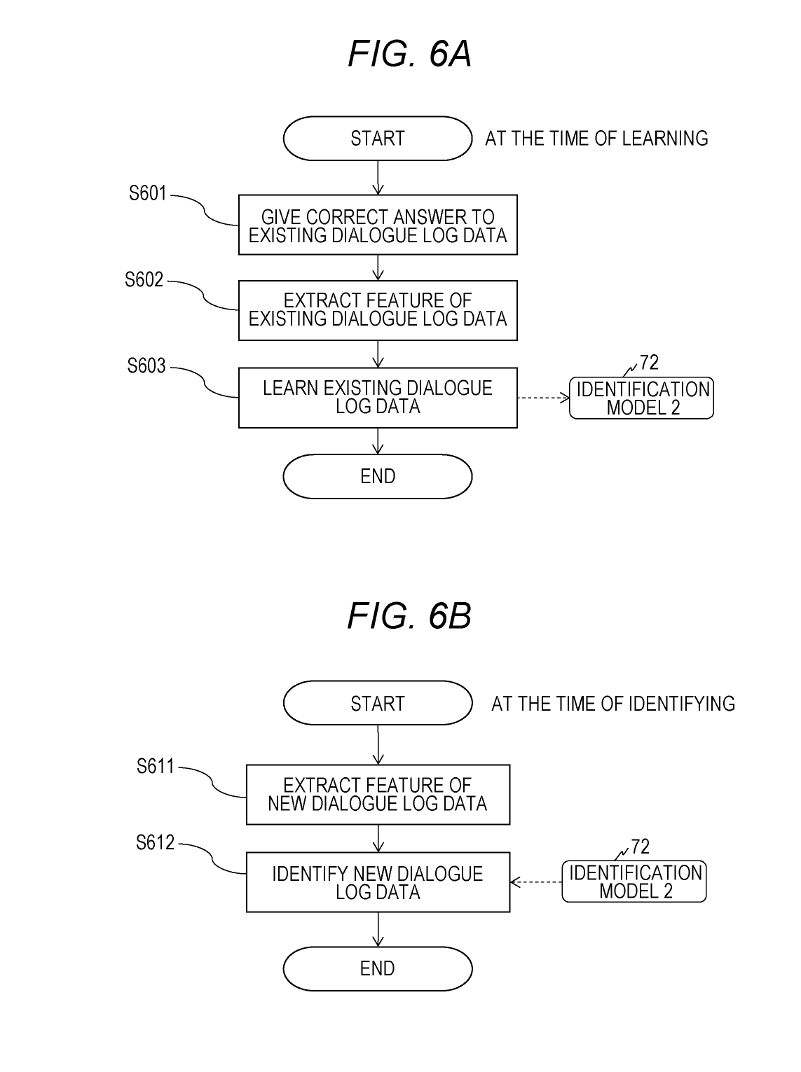

FIGS. 6A and 6B are flowcharts showing an example of failure cause analysis processing, and show examples of processing at the time of learning and at the time of identifying, respectively.

FIG. 6A is a flowchart showing an example of failure cause analysis processing at the time of learning. In the first embodiment, in the learning processing of FIG. 6A, the control unit 60 generates an identifier (an identification model 72) that analyzes a failure cause of a dialogue from the dialogue log data 30. The control unit 60 analyzes the failure cause of the dialogue in the flowchart of FIG. 6B using the identification model 72 at the time of executing the failure cause analysis processing (at the time of identifying).

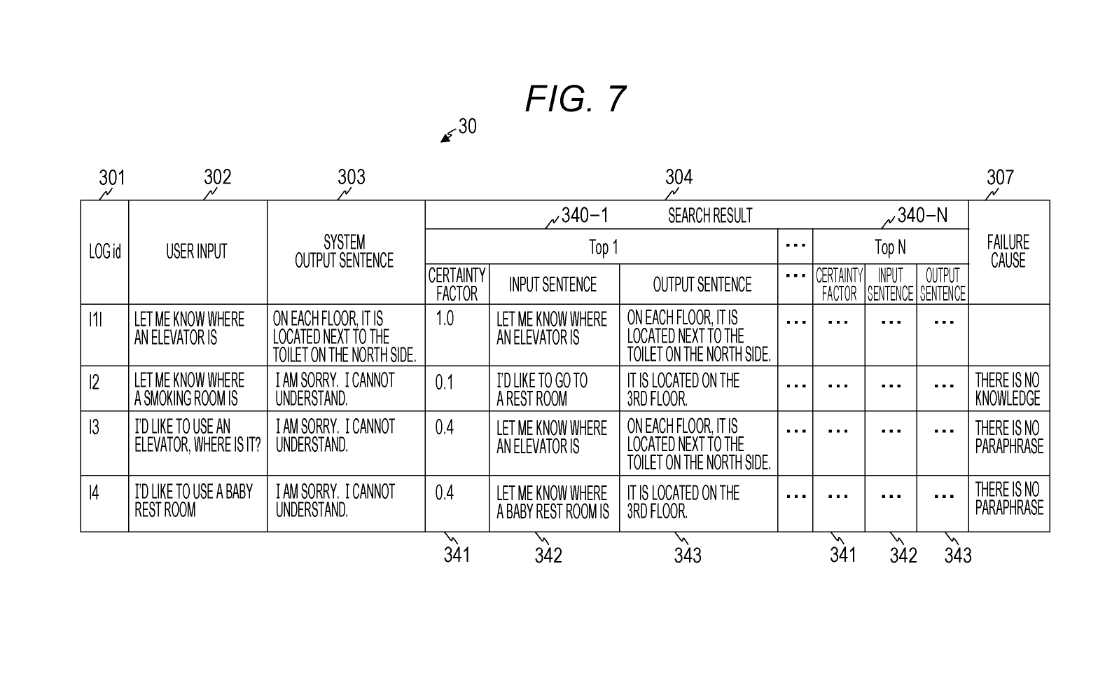

At the time of learning, in step S601, the failure cause analyzing unit 62 gives a correct answer (an analysis result) of the failure cause to the existing dialogue log data 30. FIG. 7 shows an example in which a failure cause 307 of the dialogue is given to the existing dialogue log data 30.

A log id 301, a user input 302, a system output sentence 303, and a search result 304 are the same as those of the dialogue log data 30 of FIG. 2C, and “the failure cause” 307 is a newly given label. In FIG. 7, the analysis id 305 of FIG. 2B and the success/failure 306 of FIG. 5 are omitted. It can be considered that the dialogue log data 30 includes records of which contents overlap each other, and it is also possible to use records excluding the overlaps.

In step S602, the failure cause analyzing unit 62 extracts features (or feature amounts) of the user input 302 and the system output sentence 303 of the existing dialogue log data 30 using the data obtained in step S601. As the features, for example, scores of various certainty factors or similarities obtained from the user input 302 and input sentences 342 and output sentences 343 of the tops 1 to N 340-1 to 340-N (N is a natural number) of the search result are used. The failure cause analyzing unit 62 uses, for example, values of a search engine, BLEU, or tf-idf as the scores. In addition, it is also possible to use an analysis result obtained in step S412.

In step S603, the failure cause analyzing unit 62 learns the identifier (the identification model 72) using the features of the existing dialogue log data 30 extracted in step S602. In the learning processing, the identification model 72 is generated using supervised machine learning, or the like.

FIG. 6B is a view showing step S302 of FIG. 3 in detail. At the time of identifying (S302) that actually process the dialogue log data 30 of FIG. 2B, in step S611 of FIG. 6B, the failure cause analyzing unit 62 extracts features using a new dialogue log data 30. In the extraction of the features, the same method as that of step S602 is used.

In step S612, the failure cause analyzing unit 62 identifies whether the failure cause is “there is no knowledge” or “there is no paraphrase” for the features of the new dialogue log data 30 obtained in step S611, using the identifier (the identification model 72) obtained in step S603. An identification result is output so as to be shown in, for example, a value of an item of the “failure cause” 307 of the dialogue log data 30 of FIG. 7.

After calculation of the failure cause 307 is completed, the failure cause analyzing unit 62 calculates an appearance frequency of the user input 302 from records of which contents overlap with each other and adds the success/failure 306 calculated by the failure location extracting unit 61 to generates the dialogue log analysis data 40 shown in FIG. 2C. In the first embodiment, although an example is shown in which the failure cause analyzing unit 62 generates the dialogue log analysis data 40, a confirmation processing unit 63 to be described below may also generate the dialogue log analysis data 40.

### <2-4. Confirmation Process>

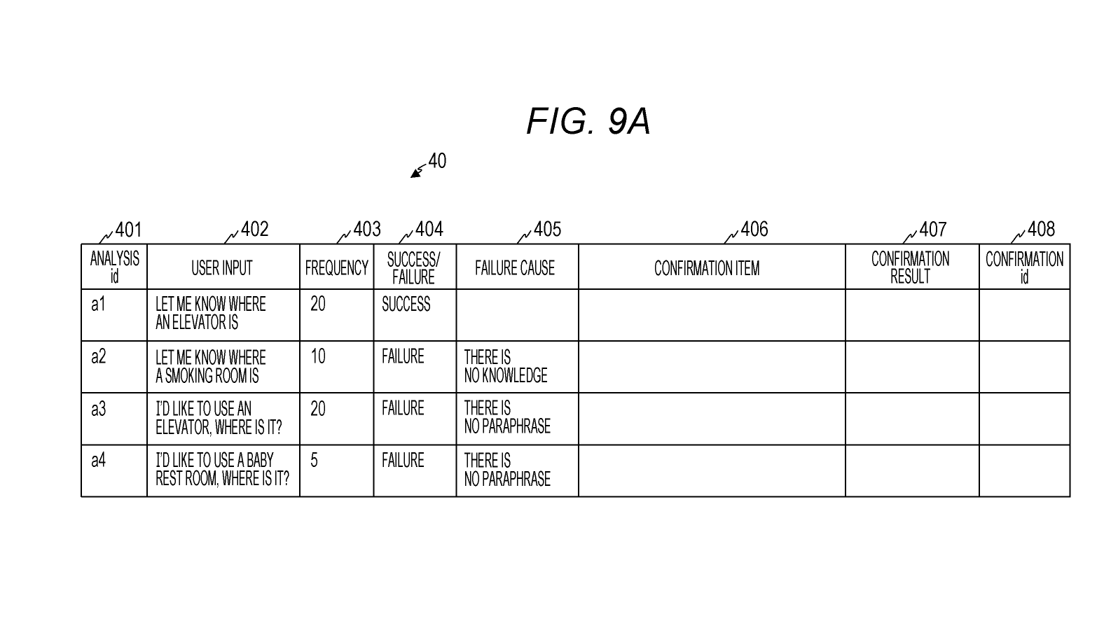

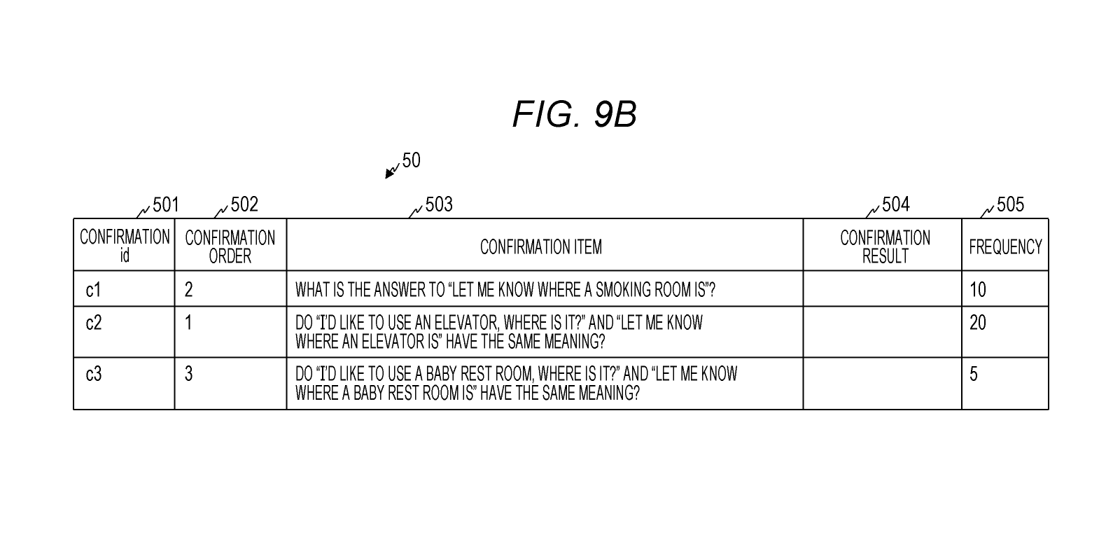

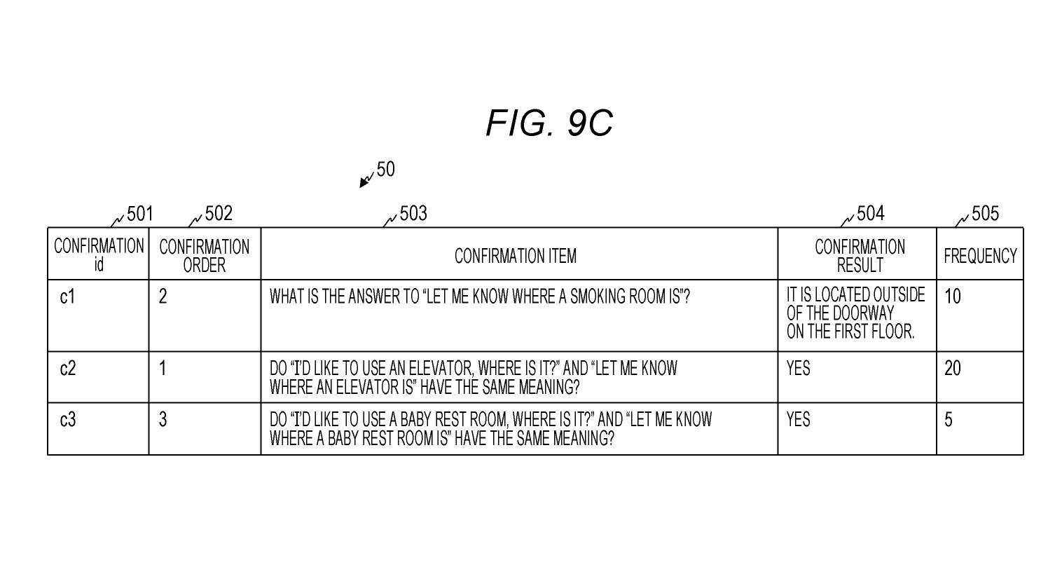

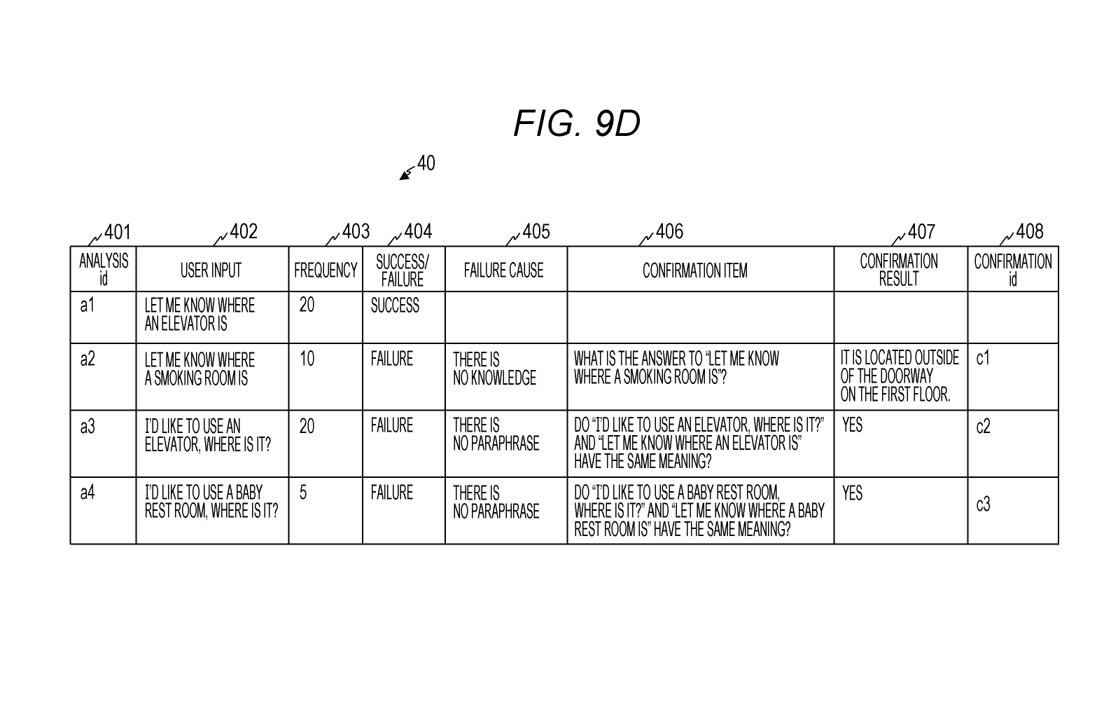

FIG. 8 is a flowchart showing steps S303 and S304 shown in FIG. 3 in detail. Steps S801 to S803 of FIG. 8 indicate confirmation processing (question generation processing), and steps S804 to S807 of FIG. 8 indicate knowledge registration processing. In FIGS. 9A to 9D, data transition is shown.

The confirmation processing unit 63 generates a value (a question sentence) of the confirmation item 406 of the dialogue log analysis data 40 using values of the analysis ids 305 and 401, the user inputs 302 and 402, and failure causes 307 (see FIGS. 7) and 405 of the dialogue log data 30 and the dialogue log analysis data 40. The confirmation processing unit 63 outputs the confirmation item 406 to inquire of the confirmer. The subsequent processing is performed by a knowledge registration processing unit 64 to be described below.

In step S801, the confirmation processing unit 63 selects a record of which a value of the success/failure 404 of the dialogue log analysis data 40 is a “failure.” The confirmation processing unit 63 selects the dialogue log data 30 of the analysis id 305 corresponding to the analysis id 401, and acquires the user input 402 (302).

In step S802, the confirmation processing unit 63 acquires the failure cause 405 of the dialogue log analysis data 40, and generates the confirmation item (the question) 406 corresponding to the failure cause. There are two types of failure causes 405: “there is no knowledge” and “there is no paraphrase.”

When the failure cause 405 is “there is no knowledge” 405, the confirmation processing unit 63 automatically generates the confirmation item 406 using the user input 402. For example, when the user input 402 is A, a sentence generated by applying a template such as “What is the answer of “A”?” is set as the confirmation item 406.

Specifically, when the analysis id 401 of the dialogue log analysis data 40 shown in FIG. 2C is a2, the user input 402 is “Let me know where a smoking room is”, and the confirmation item 406 is “What is the answer to “Let me know where a smoking room is.”?”

On the other hand, when the failure cause 405 is “there is no paraphrase”, the confirmation processing unit 63 automatically generates the confirmation item 406 using the user input 402 and an input sentence 342 of the top 1 search result 340-1. For example, when the user input 402 is A and the input sentence 342 of the top 1 search result 340-1 is B, a sentence generated by applying a template such as “Do “A” and “B” have the same meaning?” is set as the confirmation item 406.

Specifically, when the analysis id 401 of the dialogue log analysis data 40 shown in FIG. 2C is a3, the user input 402 is “I'd like to use an elevator, where is it?”=A, and the user input 402 of the top 1 search result 340-1 is “Let me know where an elevator is.”=B. In this case, the confirmation item 406 is “Do “I'd like to use an elevator, where is it?” and “Let me know where an elevator is.” have the same meaning?”

In the dialogue log analysis data 40 before this processing is performed, as shown in FIG. 9A, the confirmation item 406 is blank, and after this processing is performed, the question sentence as described above is set in the confirmation item 406.

Then, in step S803, the confirmation processing unit 63 generates the confirmation item data 50 from the dialogue log analysis data 40. The confirmation processing unit 63 can generate the confirmation item data 50 by giving a confirmation order (an output order) in a descending order of the frequency 403 of the dialogue log analysis data 40. In this case, the corresponding confirmation id 408 is set, and the dialogue log analysis data 40 is as shown in FIG. 9D.

The confirmation processing unit 63 adds a new record to the confirmation item data 50, stores the confirmation id 408 in the confirmation id 501, sets the given confirmation order to the confirmation order 502, sets the generated question sentence to the confirmation item 503, and stores the frequency 403 in the frequency 505. In this way, the confirmation item data 50 is set as shown in FIG. 9B.

In step S804, the generated confirmation item 406 (question sentence) is output to inquire of the confirmer (administrator).

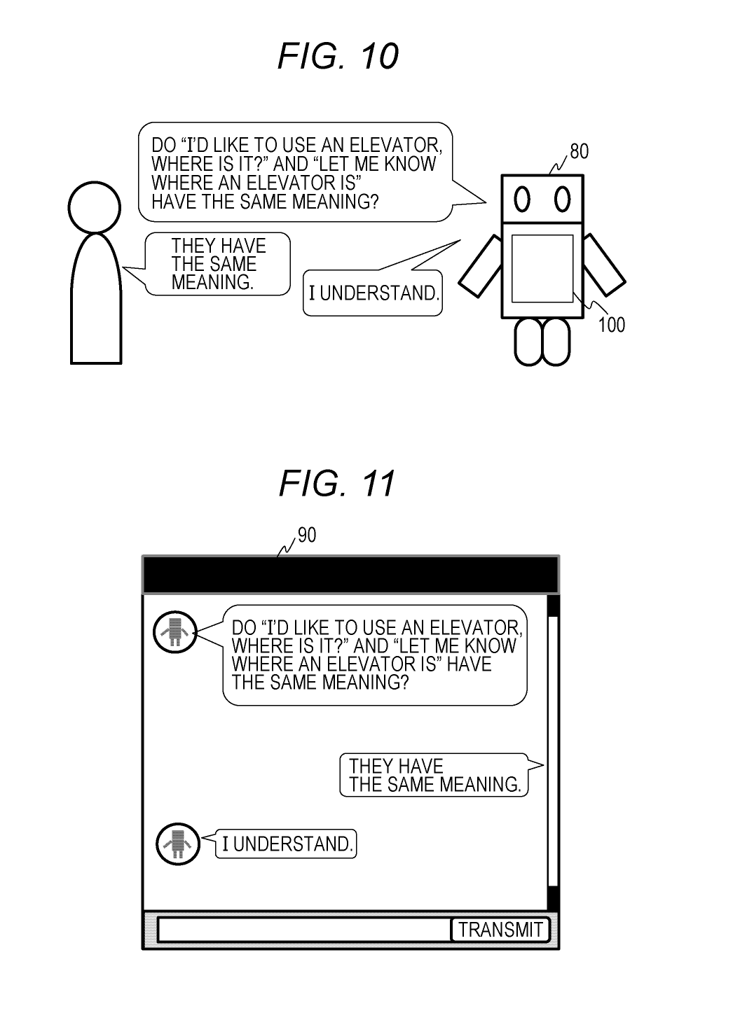

Interfaces at the time of confirmation can be provided in a plurality of forms. FIG. 10 shows an example using a robot 80, and FIG. 11 shows an example using a chat bot 90.

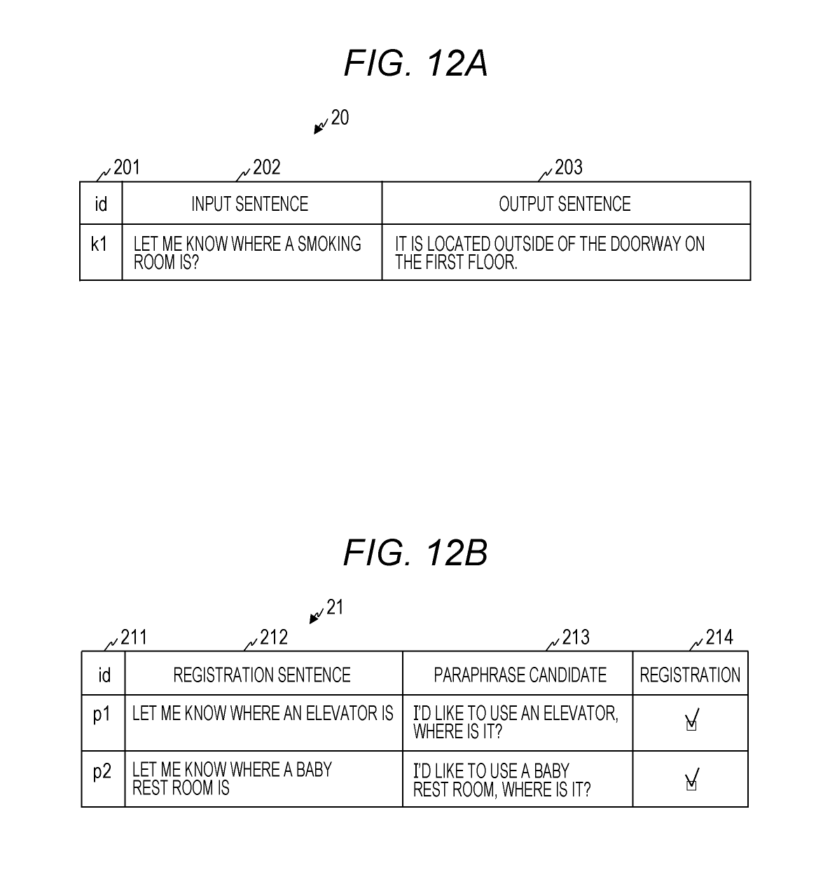

FIGS. 12A and 12B are examples using a table format. In the example using the robot 80, the confirmer inputs an answer by a voice. In the example using the chat bot 90, the confirmer inputs an answer by a text.

FIG. 12B is a view showing an example of the paraphrase candidate data 21. The paraphrase candidate data 21 includes a paraphrase id 211, a registration sentence 212, a paraphrase candidate 213, and a registration 214 in one record. The paraphrase candidate data 21 is preset information.

In the paraphrase id 211, an identifier of the registration sentence 212 is stored. In the registration sentence 212, a content of the input sentence 202 of the dialogue data 20 is registered. In paraphrase candidate 213, a synonym or a sentence of the input sentence 202 is stored. The paraphrase candidate may be associated with another input sentence 202 synonymous with the input sentence 202. The registration 214 is a check box that accepts a check when the paraphrase candidate 213 is associated with the input sentence 202.

In the example using the table form, the output sentence 203 or the paraphrase candidate 213 is input as an answer by checking the text (the input sentence 202) or the check box (the registration 214). In confirmation of new knowledge, the output sentence for the input sentence is input as a text. In confirmation of paraphrase, when the registration sentence and the paraphrase candidate have the same meaning, the check box of the registration is checked. Instead of the check box, it is also possible to input a confirmation result as a text.

### <2-5. Knowledge Registration Processing>

Steps S805 to S807 of FIG. 8 are a flowchart showing the knowledge registration processing performed in step S304 of FIG. 3 in detail. In step S805, the knowledge registration processing unit 64 waits for an answer to the inquiry output from the confirmation processing unit 63. When the answer is received, a process proceeds to step S806.

In step S806, the knowledge registration processing unit 64 stores the received answer (or response) in the confirmation result 504 of the confirmation item data 50 and the confirmation result 407 of the dialogue log analysis data 40. In this way, in the confirmation item data 50, a value is set in the confirmation result 504 as shown in FIG. 9C, and also in the dialogue log analysis data 40, a value is set in the confirmation result 407 as shown in FIG. 9D.

In step S806, the knowledge registration processing unit 64 adds new knowledge to the dialogue data 20 depending on a content of the answer. For example, when existing knowledge and a paraphrase are confirmed as shown in FIG. 12B, the knowledge registration processing unit 64 registers the paraphrase candidate 213 of which the registration 214 of FIG. 12B is checked in association with the registration sentence 212, and reflects the paraphrase candidate 213 in the input sentence 202 of the dialogue data 20.

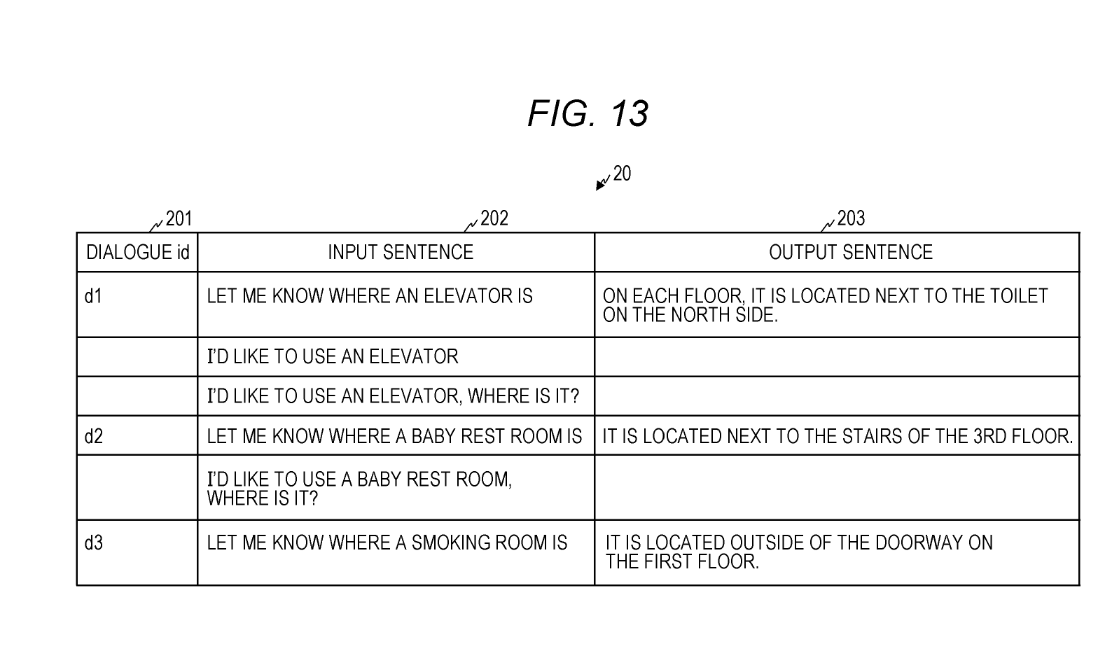

The knowledge registration processing unit 64 updates the dialogue data 20 as shown in FIG. 13 based on the dialogue log analysis data 40 of FIG. 9D. One decided that there is no knowledge in a failure cause analysis is registered as a new data.

In an example of updating the dialogue data 20 shown in FIG. 13, a case where the analysis id 401 of the dialogue log analysis data 40 shown in FIG. 9D is “a2” corresponds to a case of “failure cause analysis=there is no knowledge.” The knowledge registration processing unit 64 sets the user input 402 of the dialogue log analysis data 40 to the input sentence 202 of the dialogue data 20 and sets the confirmation result 407 of the dialogue log analysis data 40 to the output sentence 203 of the dialogue data 20 to add the dialogue id 201 as a new data of d3.

The knowledge registration processing unit 64 adds one decided that there is no paraphrase in the failure cause analysis and decided that the registration sentence 212 and the paraphrase candidate 213 are synonyms (one having the confirmation result 407 of FIG. 9D input as “Yes”) as a paraphrase of a registered sentence (the registration sentence 212).

In an example shown in FIG. 9D, a case where the analysis id 401 of the dialogue log analysis data 40 is “a3” and “a4” corresponds to a case where “there is no paraphrase in the failure cause analysis.”

A case where the analysis id 401 is “a3” is added as a paraphrase of the input sentence 202 of the dialogue data 20 that is the same as the input sentence 342 of the top 1 (Top 1) of the search result of which the analysis id 305 of the dialogue log data 30 is “a3”, to the dialogue data 20. In the dialogue data 20 shown in FIG. 13, “I'd like to use an elevator, where is it?” is added as a paraphrase to the input sentence 202.

When the analysis id 401 is “a4”, “I'd like to use a baby rest room, where is it?” is added as a paraphrase to the input sentence 202.

In addition, one decided that there is no paraphrase in the failure cause analysis and decided that the registration sentence 212 of the paraphrase candidate data 21 and the paraphrase candidate 213 are not the same as each other (one having the confirmation result 407 input as “No”) can be registered as new knowledge in the dialogue data 20 even though it is not a paraphrase, can be used at the time of answering in the next dialogue, can be excluded from an output target, or can be excluded from the confirmation item.

As described above, the information processing apparatus 1 extracts the log data failing in the dialogue from the dialogue log data 30, analyzes the failure cause, and generates the question depending on a specified failure cause, and inquires of the output apparatus of the input/output apparatus 13. When the answer is received by the input apparatus of the input/output apparatus 13, the information processing apparatus 1 can update the dialogue data 20 as new knowledge.

Through the processing described above, it is possible to expand the knowledge for answering the question that the dialogue system could not answer in the past only by answering the confirmation item (the question) from the dialogue system (the information processing apparatus 1).

### Second Embodiment

In the first embodiment, an example is shown in which an analysis of the failure cause is performed on two cases such as a case where there is no knowledge and a case where there is no paraphrase, in step S302 of FIG. 3. On the other hand, a case where there is no paraphrase includes a case where there are no synonym and an otherwise case, and when the failure cause can be precisely analyzed, a question content can be specifically represented.

Therefore, in a second embodiment, with respect to a case where there is no paraphrase” as a failure cause, an example is shown in which a failure cause analyzing unit 62 identifies two cases such as a case where “there is no synonym” and a case where “there is no paraphrase other than a synonym.” It should be noted that other configurations are the same as those of the first embodiment.

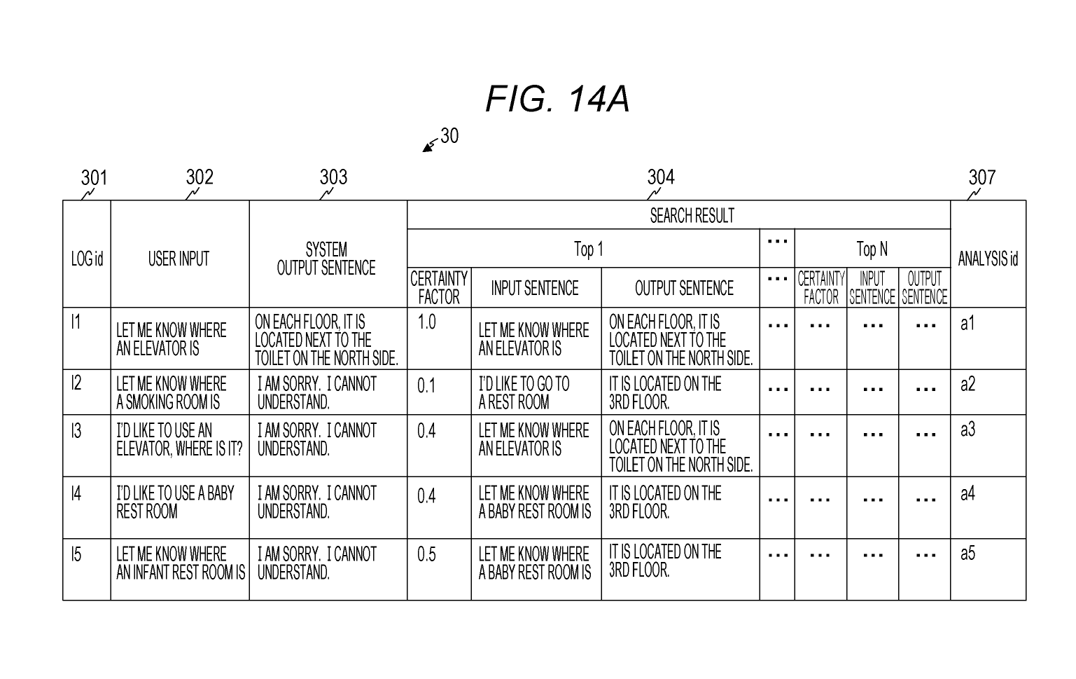

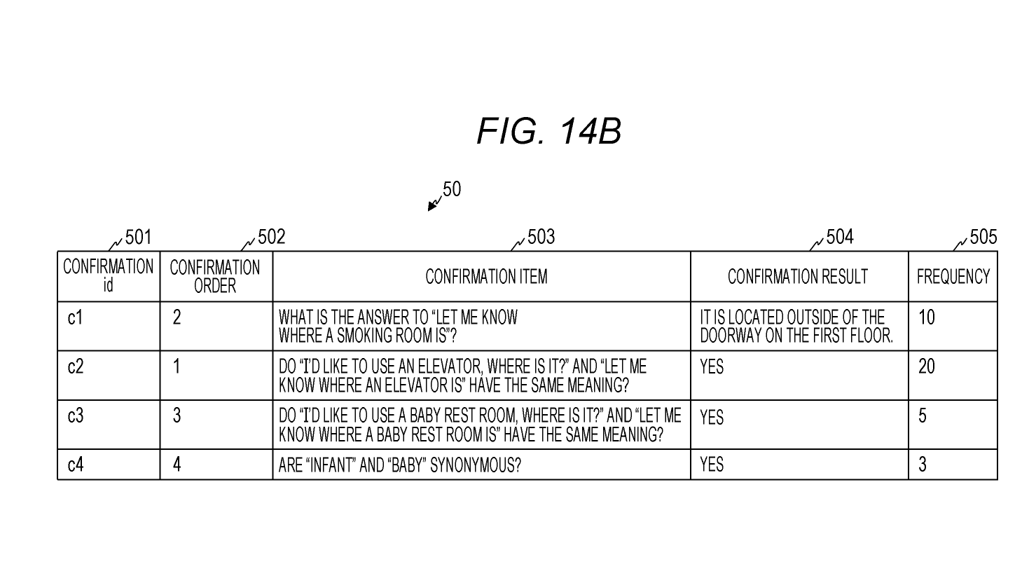

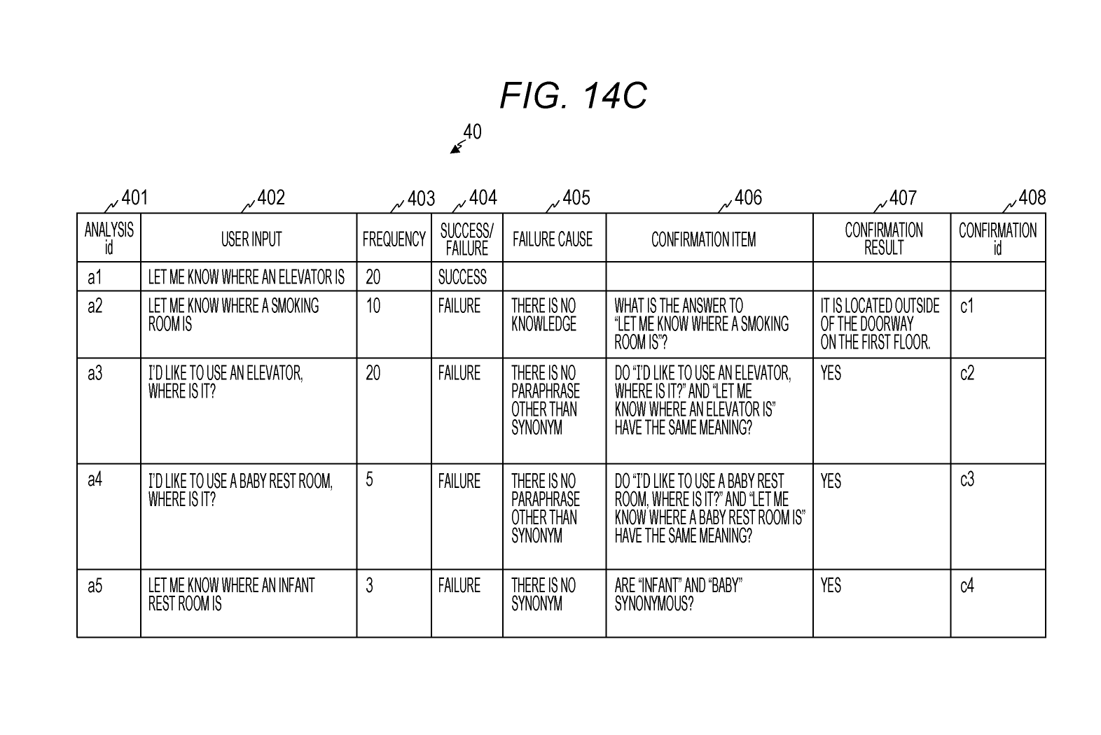

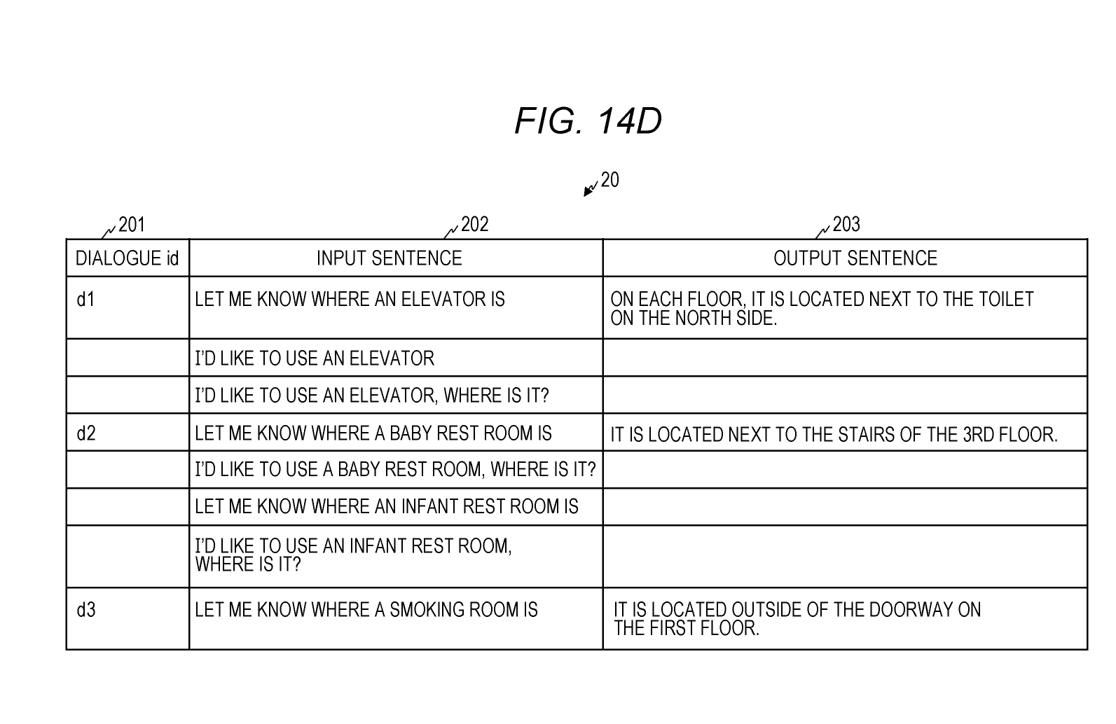

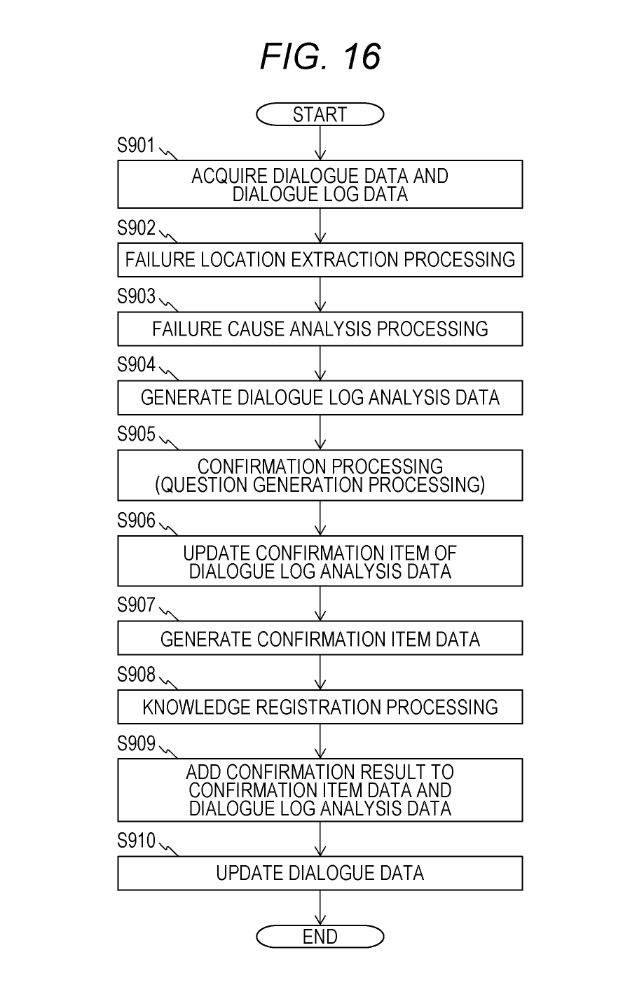

FIG. 16 is a flowchart showing an example of processing performed in the second embodiment. FIGS. 14A to 14D show transition of data at the time of analyzing a failure cause for three cases such as a case where “there is no knowledge”, a case where “there is no synonym”, and a case where “there is no paraphrase other than a synonym.”

In step S901 of FIG. 16, a failure location extracting unit 61 acquires a dialogue data 20 and a dialogue log data 30. In the second embodiment, an example is shown in which the dialogue data 200 is registered as shown in FIG. 2A and the dialogue log data 30 as shown in FIG. 14A is used.

Then, in step S902, the failure location extracting unit 61 performs failure location extraction processing as in the first embodiment, and gives a value of a success/failure 306 to the dialogue log data 30, as shown in FIG. 5.

In step S902, the failure location extracting unit 61 performs failure cause classifying processing to classify a failure cause into three cases such as a case where “there is no knowledge”, a case where “there is no synonym”, and a case where “there is no paraphrase other than a synonym.”

In step S601 of FIG. 6A in the first embodiment, two kinds of correct answer labels such as “there is no knowledge” and “there is no paraphrase” are given, and in step S903 of the second embodiment, three kinds of correct answer labels such as “there is no knowledge”, “there is no synonym”, and “there is no paraphrase other than a synonym” are given, and an identification model 72 that identifies these three kinds of correct answer labels is generated in step S603 at the time of learning as in the first embodiment.

Then, in step S903, the failure cause analyzing unit 62 analyzes a new dialogue log data 30 using the identification model 72 that identifies “there is no knowledge”, “there is no synonym”, and “there is no paraphrase other than a synonym.”

In step S904, the failure cause analyzing unit 62 generates a dialogue log analysis data 40 as shown in FIG. 14A. In addition to the above, it can be considered to identify one identified as “there is no paraphrase” as “there is no synonym” and “there is no paraphrase other than a synonym” for the analysis result of step S302 (the failure cause analysis processing) of the first embodiment.

The above identifying method includes a method of performing machine learning using a teacher data to which correct answer labels such as “there is no synonym” and “there is no paraphrase other than a synonym” are given or a method of identifying that there is no synonym when character strings of differences of a user input 302 and an input sentence 342 of the Top 1 of a search result of the dialogue log data 30 are the same part of speech.

In the latter method, for example, when the user input 302 is “Let me know where an infant rest room is” and the input sentence 342 of the Top 1 of the search result is “Let me know where a baby rest room is”, the character strings of the differences are an “infant” and a “baby.” Since parts of speech of these character strings are the same as each other as nouns, the failure cause analyzing unit 62 can identify that the failure cause is “there is no synonym.” In this case, the “infant”, which is the character string of the difference, becomes a candidate of a synonym of the “baby.”

On the other hand, when the user input 302 is “I'd like to use an elevator, where is it?” and the input sentence 342 of the Top 1 of the search result is “Let me know where an elevator is”, the character strings of the differences become “I'd like to use˜, where is it?” and “Let me know where˜is.”

In this case, parts of speech of the former are “Let (a verb) me (a pronoun) know (a verb) where (an interrogative)˜is (a verb)”, while parts of speech of the latter are “I'd (a pronoun+an auxiliary verb) like (a verb) to (a preposition) use (a verb)˜, where (an interrogative) is (a verb) it (a pronoun)?” In this example, since arrangements of the parts of speech are different from each other, the failure cause analyzing unit 62 identifies that the failure cause is “there is no paraphrase other than a synonym.”

In the second embodiment, when the failure cause is “there is no knowledge” and “there is no paraphrase other than a synonym”, in confirmation processing of step S905, a confirmation item 503 is generated by the same method as that of the first embodiment.

When the failure cause is “there is no synonym”, in the confirmation processing in step S905, a confirmation processing unit 63 sets character strings which are character strings of the differences of the user input 302 and the input sentence 342 of the Top 1 of the search result and are the same part of speech as a synonym candidate.

When the character string of the difference of the user input 302 is A and the character string of the difference of the input sentence 342 of the Top 1 of the search result is B, the confirmation item 503 is “A and B are synonymous?” In a case of the example of the “infant” and the “baby” described above, the confirmation item 503 such as “Are “infant” and “baby” synonymous?” is generated.

In step S906, the confirmation processing unit 63 set a confirmation item 406 shown in FIG. 14C to the dialogue log analysis data 40. In step S907, the confirmation processing unit 63 generates a confirmation item data 50 as shown in FIG. 14B based on the confirmation item 406, and gives a confirmation id 408 to the dialogue log analysis data 40. In addition, the confirmation processing unit 63 outputs the confirmation item 406 to inquire of a confirmer.

In step S908, a knowledge registration processing unit 64 receives an answer (or a response) from the confirmer. In step S909, the knowledge registration processing unit 64 stores a confirmation result 504 as shown in FIG. 14B in the confirmation item data 50, and stores a confirmation result 407 as shown in FIG. 14C in the dialogue log analysis data 40.

Then, in step S910, the knowledge registration processing unit 64 updates the dialogue data 20 as shown in FIG. 14D using the dialogue data 20 and the dialogue log analysis data 40. When a character string in which there is a synonym appears in an input sentence 202, the knowledge registration processing unit 64 newly adds a sentence replaced with the synonym as a paraphrase of the input sentence 202.

In a case of a dialogue data 20 of FIG. 14D, for “Let me know where a baby rest room is” and “I'd like to use a baby rest room, where is it?”, a “baby” is replaced with an “infant”, and “Let me know where an infant rest room is” and “I'd like to use an infant rest room, where is it?” are added as a new paraphrase.

The failure analysis is performed in consideration of the synonym as described above, the failure cause can be more precisely confirmed as compared with a paraphrase such as “Are “infant” and “baby” synonymous?” In addition, it is possible to generate a paraphrase sentence in which a synonym is replaced and to more efficiently prepare the paraphrase sentence.

### Third Embodiment

Although there is no overlap in the confirmation item data 50 by the knowledge registration processing of steps S805 to S807 in the first embodiment, the confirmation item 406 is prepared for each user input 402 identified as the “failure” in step S301 of FIG. 3. For this reason, a similar question may be included in the confirmation items 406.

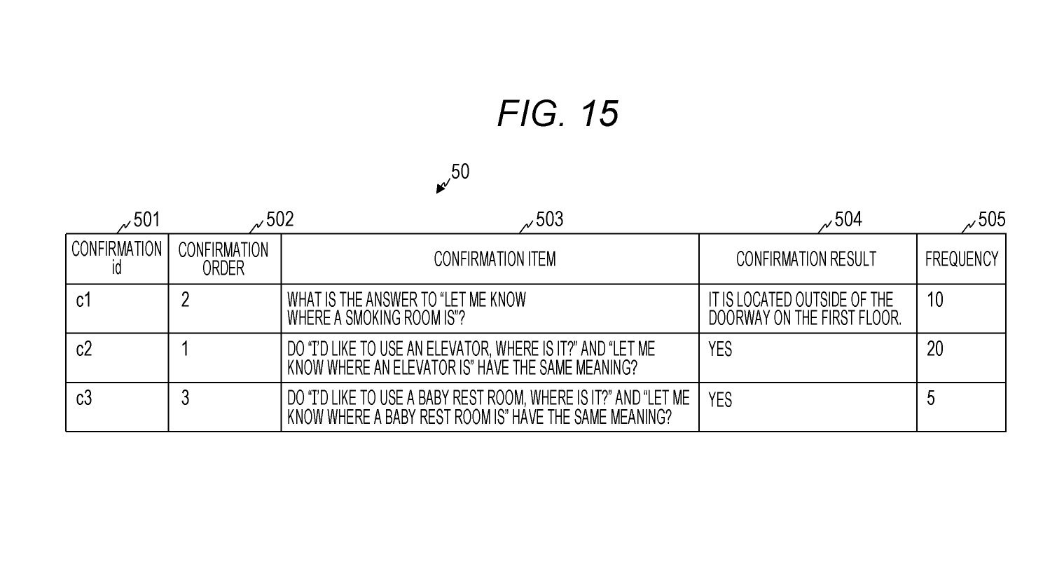

An example is described in which an analysis id 401 of a dialogue log analysis data 40 of FIG. 15 is “a3” and “a4.”

A confirmation item in a case where the analysis id 401 is “a3”: Do “I'd like to use an elevator, where is it?” and “Let me know where an elevator is.” have the same meaning?

A confirmation item in a case where the analysis id 401 is “a4”: Do “I'd like to use a baby rest room, where is it?” and “Let me know where a baby rest room is.” have the same meaning?

The character strings of the differences are an “elevator” and a “baby rest room”, and when any one of the confirmation items is inquired of a confirmer and an answer is applied to the other of the confirmation items, confirmation processing for the other of the confirmation items by the confirmer can be omitted.

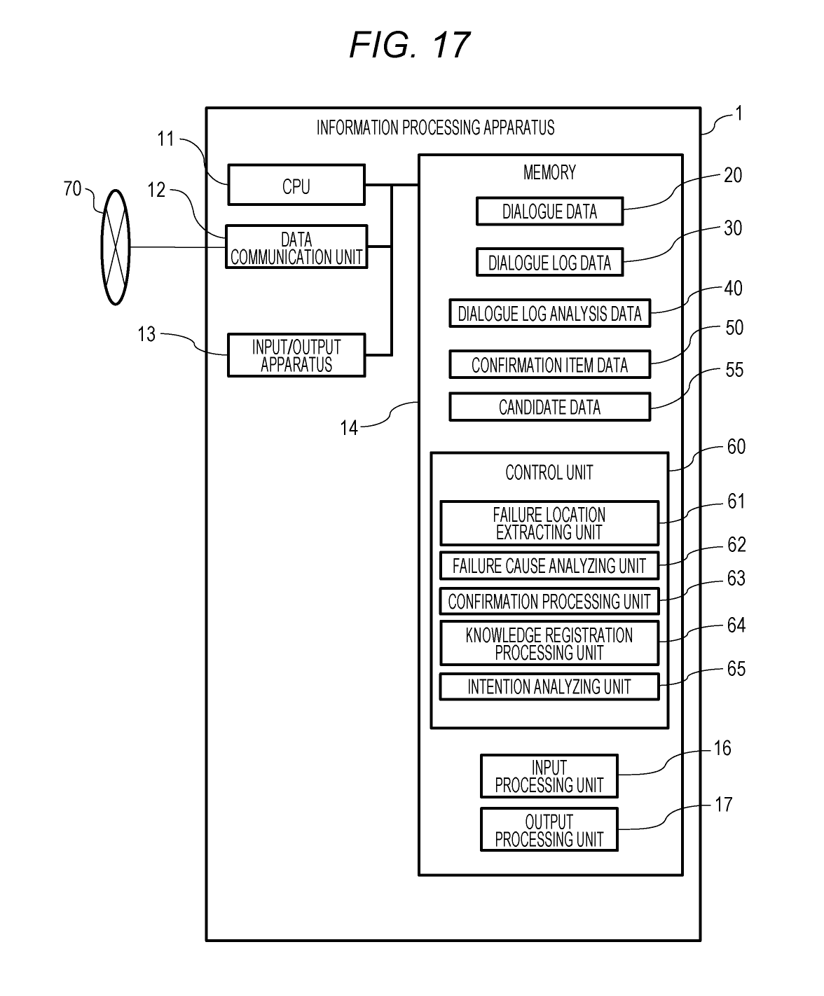

Therefore, in the third embodiment, as shown in FIG. 17, an example of adding a candidate data 55 of a paraphrase and an intention analyzing unit 65 that generates the candidate data 55 to the information processing apparatus 1 is shown. It should be noted that other configurations are the same as those of the first embodiment described above.

The intention analyzing unit 65 analyzes the intention of a user input 302 of a dialogue log data 30. That is, the intention analyzing unit 65 detects a user input 302 close to a user input 302 input from a user from the user input 302 registered in the dialogue log data 30 and a system output sentence 303. The intention analyzing unit 65 can register the detected user input 302 as the candidate data 55 of the paraphrase, and generate a confirmation item 406 (a question sentence) by the paraphrase as in the first embodiment. The candidate data 55 of the paraphrase may be configured in the same way as the paraphrase candidate data 21 shown in FIG. 12B.

A confirmation processing unit 63 generates and outputs a confirmation item 503 from the candidate data 55 as in the first embodiment. When an answer corresponding to the confirmation item 503 is received, a knowledge registration processing unit 64 can register the paraphrase as new knowledge in a dialogue data 20.

According to the third embodiment, it can be expected that a paraphrase sentence can be efficiently prepared.

### Fourth Embodiment

In the first embodiment, although an example is shown in which the information processing apparatus 1 specifies the failure cause of the dialogue from the dialogue log data 30 and generates the new knowledge, in a fourth embodiment, a dialogue system including an information processing apparatus 1 that collects dialogue log data from one or more robots to update a dialogue data 20 is shown.

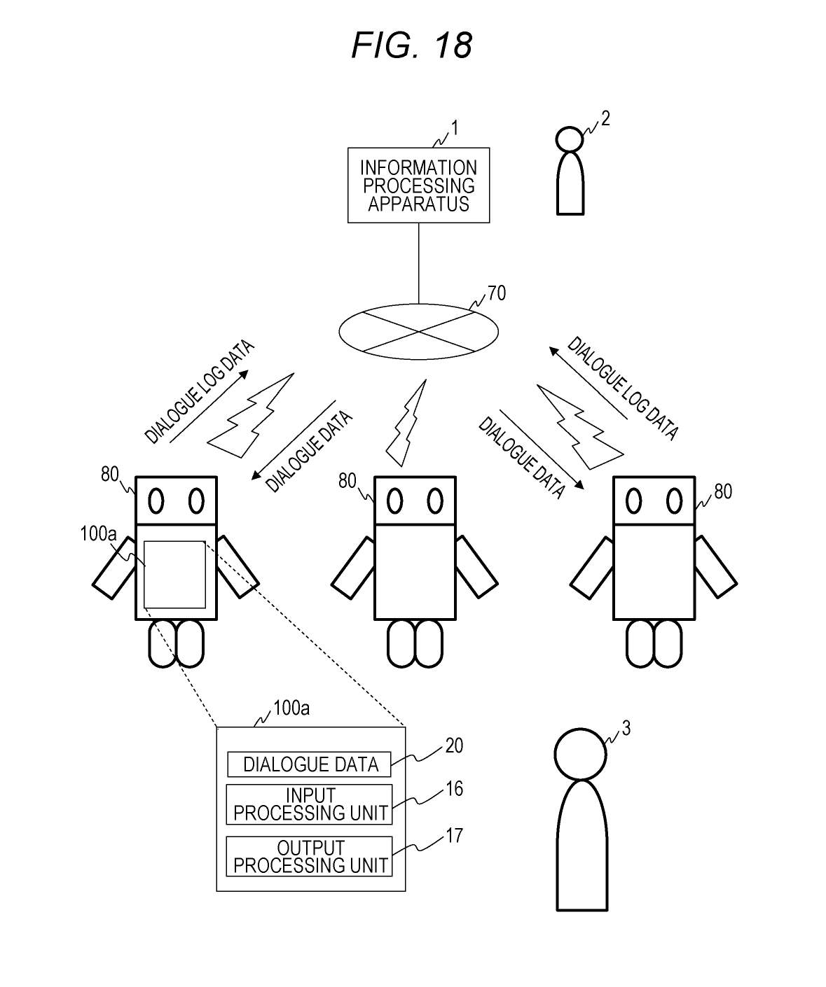

FIG. 18 is a block diagram showing an example of a dialogue system according to a fourth embodiment. The dialogue system includes one or more robots 80a, an information processing apparatus 1 that manages the robots 80a, and a network 70 that connects the robots 80a and the information processing apparatus 1 to each other.

The robot 80a includes an information processing apparatus 100a including a dialogue data 20, an input processing unit 16, and an output processing unit 17 that are the same as those of the first embodiment, and performs a dialogue with a user 3. It should be noted that although not shown, the information processing apparatus 100a includes a data communication unit 12 and an input/output apparatus 13, similar to the information processing apparatus 1 according to the first embodiment.

In the information processing apparatus 100a, the input processing unit 16 receives an utterance from the user 3, and outputs an appropriate system output sentence from the dialogue data 20. The output processing unit 17 transmits a dialogue result as a dialogue log data 30 to the information processing apparatus 1.

The information processing apparatus 1 performs failure location extraction processing and failure cause analysis processing using the dialogue log data 30 received from the robot 80a, similar to the first embodiment, and generates dialogue data 20 as new knowledge and transmits the dialogue data 20 to the robot 80a, after an administrator 2 confirms a failure of the dialogue when the dialogue fails.

The robot 80a adds the new dialogue data 20 received from the information processing apparatus 1 to prepare for the next dialogue.

As described above, in the fourth embodiment, it is possible to expand knowledge for answering the question that the robots 80a could not answer in the past only by collecting the dialogue log data 30 of one or more robots 80a and answering the confirmation item (the question) by the information processing apparatus 1.

In addition, in the fourth embodiment, it is possible to add the dialogue data 20 of all the robots 80a from the dialogue log data 30 accumulated in the information processing apparatus 1. Therefore, it is possible to uniformly maintain dialogue capability with each of the robots 80a. In addition, it is possible to reduce maintenance of the dialogue data 20 of the robots 80a, such that it is possible to reduce an operation cost.

The failure location extraction processing, the failure cause analysis processing, and the generation of the new knowledge by the information processing apparatus 1 may be performed in real time or may be performed at a preset timing.

It should be noted that the present invention is not limited to the abovementioned embodiments, and includes various modified examples. For example, the abovementioned embodiments have been described in detail in order to easily explain the present invention, and are not necessarily limited to including all the components described above. In addition, some of components of any embodiment can be replaced with components of another embodiment, and components of another embodiment can be added to components of any embodiment. In addition, addition, deletion, or replacement of other components can be applied alone or in combination to some of components of each embodiment.

In addition, the abovementioned components, functions, processing units, processing means, and the like, may be implemented by hardware by designing some or all of them with, for example, integrated circuits. In addition, the abovementioned respective components, functions, and the like, may be implemented by software by processors interpreting and executing programs for implementing the respective functions. Information such as programs, tables, or files for implementing the respective functions can be stored in a recording apparatus such as a memory, a hard disk, or a solid state drive (SSD), or a recording medium such as an integrated circuit (IC) card, a secure digital (SD) card, or a digital versatile disk (DVD).

In addition, only control lines or information lines considered to be required for explanation are shown, and all control lines and information lines of products are not necessarily shown. It may be considered that almost all components are actually connected to each other.

What is claimed is:

1. An information processing apparatus that has a processor and a memory and analyzes a dialogue log data including an input sentence from a user and an answer to the input sentence as an output sentence, comprising:
a failure location detecting unit that receives the dialogue log data and detects a failure location of a dialogue from the dialogue log data;
a failure cause analyzing unit that analyzes a failure cause from the dialogue log data corresponding to the failure location;
a confirmation processing unit that generates and outputs a question sentence from the dialogue log data depending on the failure cause; and
a knowledge registration processing unit that receives an answer to the question sentence and adds the answer as new knowledge to a dialogue data for obtaining an output sentence from the input sentence.

2. The information processing apparatus according to claim 1, wherein
the failure cause analyzing unit
identifies the failure cause into two cases: a case where there is no knowledge in the dialogue data and a case where there is no paraphrase in the dialogue data.

3. The information processing apparatus according to claim 1, wherein
the failure cause analyzing unit
identifies the failure cause into three cases: a case where there is no knowledge in the dialogue data, a case where there is no paraphrase in the dialogue data, and a case where there is no synonym in the dialogue data.

4. The information processing apparatus according to claim 1, wherein
the failure location detecting unit calculates features of the input sentence and the output sentence of the dialogue log data and detects the failure location of the dialogue based on the features, and
the failure cause analyzing unit
calculates features of the input sentence and the output sentence of the dialogue log data and generates the failure cause based on the features.

5. The information processing apparatus according to claim 1, wherein
the confirmation processing unit
determines an output order depending on an appearance frequency of a dialogue log data corresponding to the question sentence.

6. The information processing apparatus according to claim 1, wherein
the confirmation processing unit
outputs the question sentence in a table format.

7. The information processing apparatus according to claim 1, wherein
the confirmation processing unit
outputs the question sentence in a state where a synonym is included in the question sentence, and
the knowledge registration processing unit
receives a synonym included in the answer to the question sentence and adds the synonym as new knowledge to the dialogue data.

8. A dialogue processing method that analyzes a dialogue log data including an input sentence from a user and an answer to the input sentence as an output sentence, by an information processing apparatus having a processor and a memory, comprising:
a first step of receiving the dialogue log data and detecting a failure location of a dialogue from the dialogue log data, by the information processing apparatus;
a second step of analyzing a failure cause from the dialogue log data corresponding to the failure location, by the information processing apparatus;
a third step of generating and outputting a question sentence from the dialogue log data depending on the failure cause, by the information processing apparatus; and
a fourth step of receiving an answer to the question sentence and adding the answer as new knowledge to a dialogue data for obtaining an output sentence from the input sentence.

9. The dialogue processing method according to claim 8, wherein
in the second step,
the failure cause is identified into two cases: a case where there is no knowledge in the dialogue data and a case where there is no paraphrase in the dialogue data.

10. The dialogue processing method according to claim 8, wherein
in the second step,
the failure cause is identified into three cases: a case where there is no knowledge in the dialogue data, a case where there is no paraphrase in the dialogue data, and a case where there is no synonym in the dialogue data.

11. The dialogue processing method according to claim 8, wherein
in the first step,
features of the input sentence and the output sentence of the dialogue log data are calculated and the failure location of the dialogue is detected based on the features, and
in the second step,
features of the input sentence and the output sentence of the dialogue log data are calculated and the failure cause is generated based on the features.

12. The dialogue processing method according to claim 8, wherein
in the third step,
an output order is determined depending on an appearance frequency of a dialogue log data corresponding to the question sentence.

13. The dialogue processing method according to claim 8, wherein
in the third step,
the question sentence is output in a table format.

14. The dialogue processing method according to claim 8, wherein
in the third step,
the question sentence is output in a state where a synonym is included in the question sentence, and
in the fourth step,
a synonym included in the answer to the question sentence is received and the synonym is added as new knowledge to the dialogue data.

15. A dialogue system comprising:
an information processing apparatus that has a processor and a memory; and
a robot that is connected to the information processing apparatus through a network, wherein
the robot
receives an input sentence from a user, outputs an answer to the input sentence as an output sentence from a preset dialogue data, generates a dialogue log data including the input sentence and the output sentence, and transmits the dialogue log data to the information processing apparatus, and
the information processing apparatus includes:
a failure location detecting unit that receives the dialogue log data and detects a failure location of a dialogue from the dialogue log data;
a failure cause analyzing unit that analyzes a failure cause from the dialogue log data corresponding to the failure location;
a confirmation processing unit that generates and outputs a question sentence from the dialogue log data depending on the failure cause; and
a knowledge registration processing unit that receives an answer to the question sentence, adds the answer as new knowledge to a dialogue data for obtaining an output sentence from the input sentence, and transmits the dialogue data to the robot.
